(19) United States
(12) Patent Application Publication
(10) Pub. No.: US 2025/0379401 A1
(43) Pub. Date: Dec. 11, 2025

(54) ELECTRICAL CONNECTOR

(71) Applicant: Omnetics Connector Corporation, Minneapolis, MN (US)

(72) Inventor: ERIC M. BERGQUIST, Minneapolis, MN (US)

(73) Assignee: Omnetics Connector Corporation, Minneapolis, MN (US)

(21) Appl. No.: 18/736,377

(22) Filed: Jun. 6, 2024

(51) Int. Cl. H01R 13/627; B33Y 80/00; H01R 12/70; H01R 13/50

(52) U.S. Cl. CPC H01R 13/6273; H01R 12/707; H01R 13/50; B33Y 80/00

(57) ABSTRACT

An electrical connector assembly includes an electrical connector. The electrical connector includes a shell, contact block and at least one electrical contact. The shell includes an opening at a first end, and a channel extending from the opening and toward a second end. The shell includes one or more latch arms that extend from an anchor and continue toward the first end to a tip. The latch arms have a contact region at an intermediate position between the anchor and the tip and are flexible about the anchor and flexible about the contact region in response to the contact region engaging a contact portion of the shell. The contact block is positioned at least partially within the opening and includes a mating interface. The shell may also include a mounting fin having ridges that cooperate with the mounting fin to form a solder channel when mounted to a circuit board.

### BACKGROUND

Electrical connectors are used to join electrical circuits together, enabling the transmission of power or signals between different devices or components. These connectors come in various forms, sizes, and complexities, tailored to specific applications ranging from simple household appliances to sophisticated equipment. The effectiveness and reliability of electrical connectors are critical to the overall performance of the electrical system, and as such, there is a constant need for improvements in connector design.

### SUMMARY

In general terms, this disclosure is directed to an electrical connector. In some embodiments, and by non-limiting example, the electrical connector has at least a shell, a contact block, and at least one electrical contact. The shell includes an opening extending from a first end and continuing toward a second end. The shell includes a pair of latch arms. The pair of latch arms extend from an anchor and continue toward the first end to a tip. The pair of latch arms have a contact region at an intermediate position between the anchor and the tip. The pair of latch arms are pivotable in a first phase and a second phase, the first phase corresponding to flexing initiating proximate about the anchor, and second phase corresponding to flexing concentrating proximate to the latch arm in response to the contact region engaging a contact portion of the shell. The contact block is positioned at least partially within the opening. The contact block includes a mating interface. The at least one electrical contact is connected to the contact block with a first contact end at the mating interface.

In another embodiment, a connector includes a shell with a main body and a mounting fin. The mounting fin extends from an exterior surface of the shell in a first direction. The mounting fin has a first side and a second side. Each of the first and second sides includes a plurality of ridges extending in the first direction along at least a portion of the mounting fin. Neighboring ridges of the plurality of ridges form solder channels between them. The connector also includes a contact block positioned at least partially within the opening. The contact block includes a mating interface of the contact block. The connector also includes at least one electrical contact connected to the contact block with a first contact end at the mating interface.

In another embodiment, a shell for an electrical connector includes a main body having an opening at a first end and forming a channel that extends from the opening and toward a second end within the main body. The shell includes a pair of latch arms integrally formed with the main body and positioned at least partially within the opening, the pair of integral latch arms being flexible in first and second phases, the first phase corresponding to flexing initiating proximate an anchor and the second phase corresponding to flexing initiating proximate a contact region of the pair of latch arms in response to the contact region engaging a contact portion on an interior surface of the main body.

### BRIEF DESCRIPTION OF THE DRAWINGS

Non-limiting and non-exhaustive examples are described with reference to the following figures:

FIG. 1 is a front perspective view of an example connector in accordance with the principles of the present disclosure.

FIG. 2 is a front view of the connector of FIG. 1.

FIG. 3 is a rear view of the connector of FIG. 1.

FIG. 4 is a top view of the connector of FIG. 1.

FIG. 5 is bottom view of the connector of FIG. 1.

FIG. 6 is a first side view of the connector of FIG. 1.

FIG. 7 is a second side view of the connector of FIG. 1.

FIG. 8 is a first front perspective view of an example connector shell in accordance with the principles of the present disclosure.

FIG. 9 is a second front perspective view of the connector shell of FIG. 8.

FIG. 10 is a first rear perspective view of the connector shell of FIG. 8.

FIG. 11 is a second rear perspective view of the connector shell of FIG. 8.

FIG. 12 is a front view of the connector shell of FIG. 8.

FIG. 13 is a rear view of the connector shell of FIG. 8.

FIG. 14 is a top view of the connector shell of FIG. 8.

FIG. 15 is a bottom view of the connector shell of FIG. 8.

FIG. 16 is a first side view of the connector shell of FIG. 8.

FIG. 17 is a second side view of the connector shell of FIG. 8.

FIG. 18 is a front perspective view of another example connector in accordance with the principles of the present disclosure.

FIG. 19 is a front view of the connector of FIG. 18.

FIG. 20 is a rear view of the connector of FIG. 18.

FIG. 21 is a top view of the connector of FIG. 18.

FIG. 22 is a bottom view of the connector of FIG. 18.

FIG. 23 is a first side view of the connector of FIG. 18.

FIG. 24 is a second side view of the connector of FIG. 18.

FIG. 25 is a front perspective view of another example connector shell in accordance with the principles of the present disclosure.

FIG. 26 is a front view of the connector shell of FIG. 25.

FIG. 27 is a rear view of the connector shell of FIG. 25.

FIG. 28 is a top view of the connector shell of FIG. 25.

FIG. 29 is a bottom view of the connector shell of FIG. 25.

FIG. 30 is a first side view of the connector shell of FIG. 25.

FIG. 31 is a second side view of the connector shell of FIG. 25.

FIG. 32 is a first cross-sectional view of the connector of FIG. 8.

FIG. 33 is a second cross-sectional view of the connector of FIG. 8.

FIG. 34 is a perspective view of the connector of FIG. 1 connected to a printed circuit board.

FIG. 35 is a cross-sectional view of FIG. 34 showing an example mounting fin within an example printed circuit board slot.

FIG. 36 is a perspective view of the connector of FIG. 18 connected to a printed circuit board.

FIG. 37 is a perspective view of the connector of FIG. 1 attached to an example printed circuit board and an example plug.

FIG. 38 is a cross sectional view of FIG. 37 when the plug is in an engaged position.

FIG. 39 is a cross-sectional view of FIG. 37 when the plug is in an insertion position.

FIG. 40 is a perspective view of an example contact block.

FIG. 41 is an exploded side view of an example plug, shell, and contact block in accordance with the principles of the present disclosure.

FIG. 42 is a perspective view of an example plug in accordance with the principles of the present disclosure.

FIG. 43 is a perspective view of an example contact block partially inserted in an example shell in accordance with the principles of the present disclosure.

FIG. 44A is an example stress illustration of an example latch arm just prior to first contact with an example plug.

FIG. 44B is an example stress illustration of the latch arm and plug of FIG. 44A just after first contact between the latch arm and the plug.

FIG. 44C is an example stress illustration of the latch arm and plug of FIG. 44A during insertion of the plug and just as contact is made between the latch arm and a contact region of a shell.

FIG. 44D is an example stress illustration of the latch arm and plug of FIG. 44A during insertion of the plug when the latch arm is maximally deflected by the plug.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

In accordance with the present disclosure, an electrical connector assembly includes a socket, or jack, and a complementary electrical plug. The electrical connector assembly described herein includes an electrical connector (also referred to as a socket or jack) and an electrical plug that mates with the electrical connector in a complementary manner. In examples, the electrical connector assembly provides a compact, shielded electrical connection arrangement usable in circumstances where high reliability is required.

Advancements in manufacturing technology have enabled further advancements in electrical connector design. In accordance with certain aspects of the present disclosure, the electrical connector may include various connector latch arm innovations and soldering pin/fin designs. Certain aspects of the present disclosure relate to electrical connector designs enabled by 3D printing. Further aspects will be apparent from the disclosure below. The example embodiments described below are illustrated using a single type or family of electrical connectors, but the inventive aspects apply equally to many other types of connectors. For instance, the connector may be a round or rectangular style connector. The connector may be of different styles for different uses, for example a USB-C, RJ45, HDMI, Micro-D, or Nano-D connector.

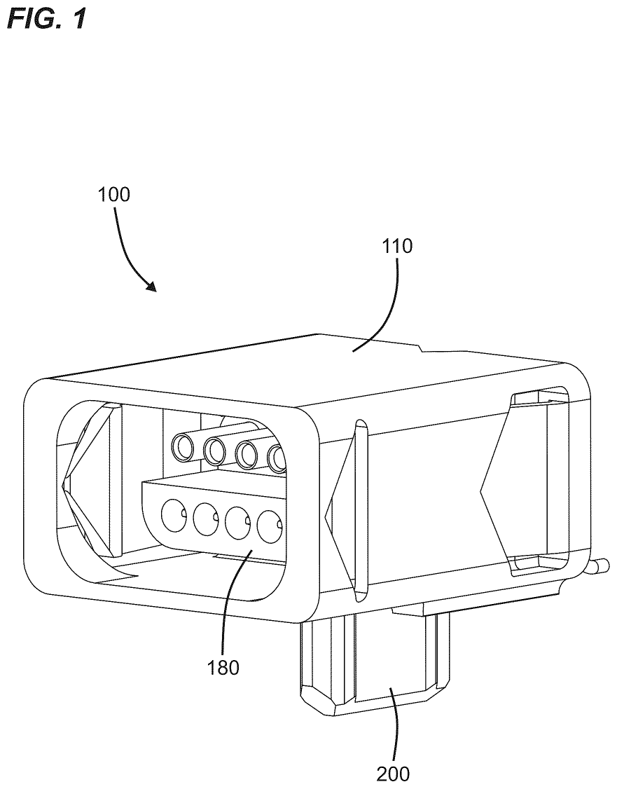

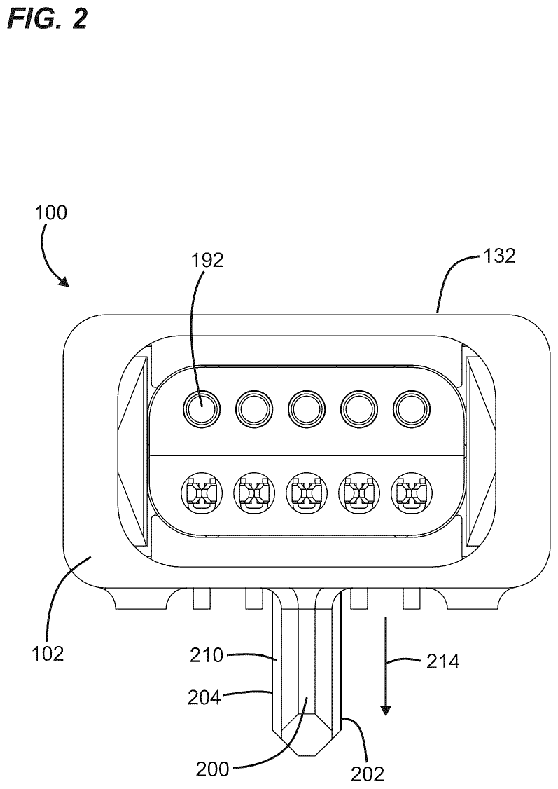

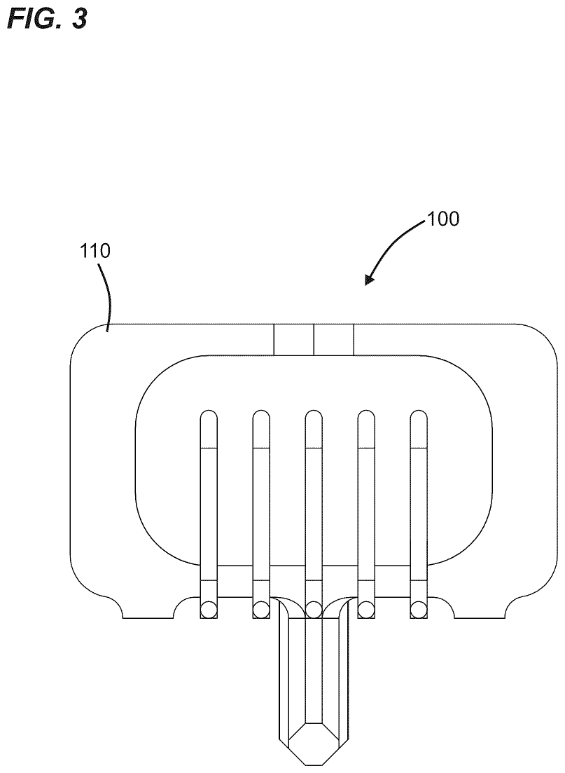

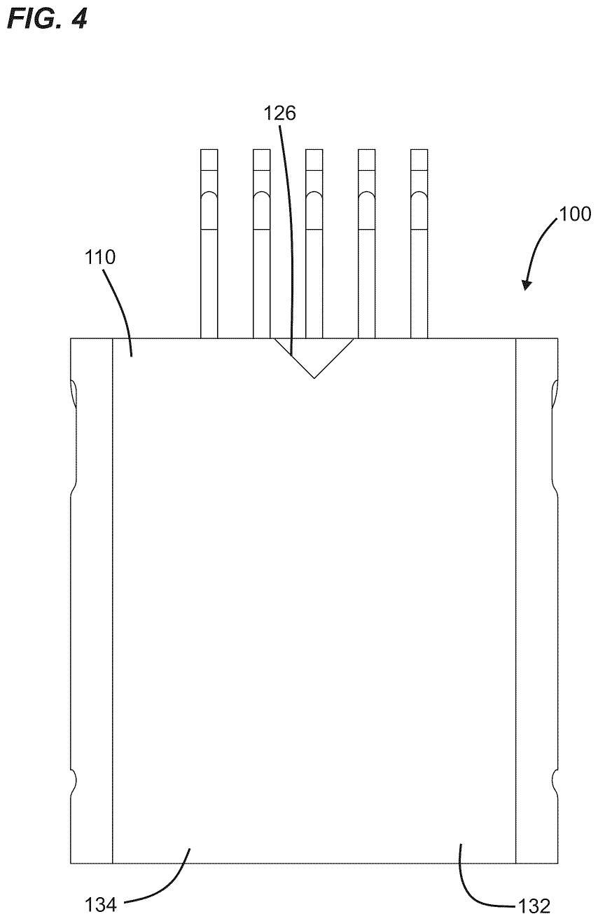

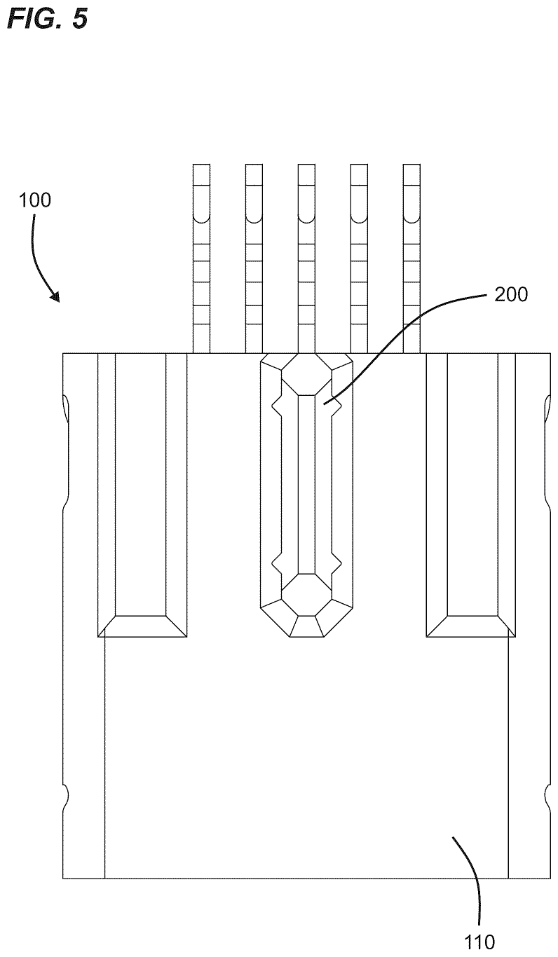

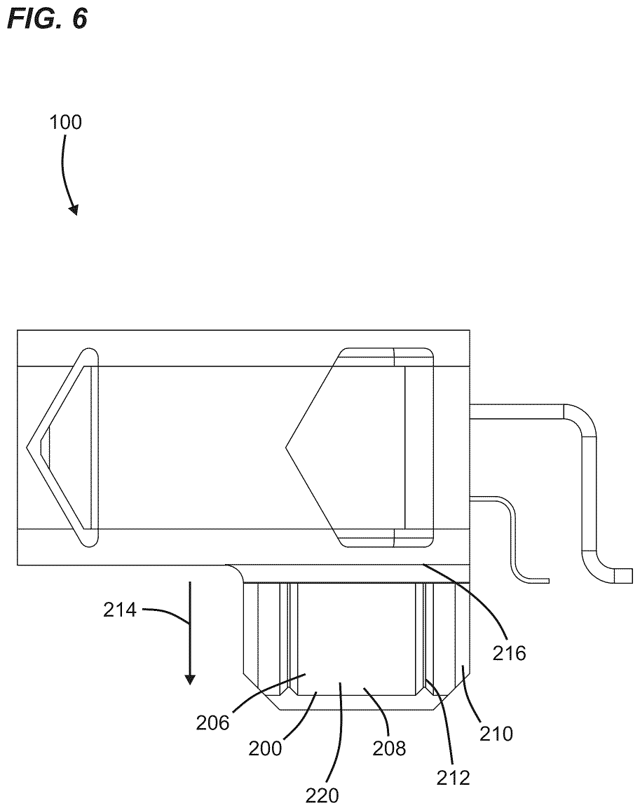

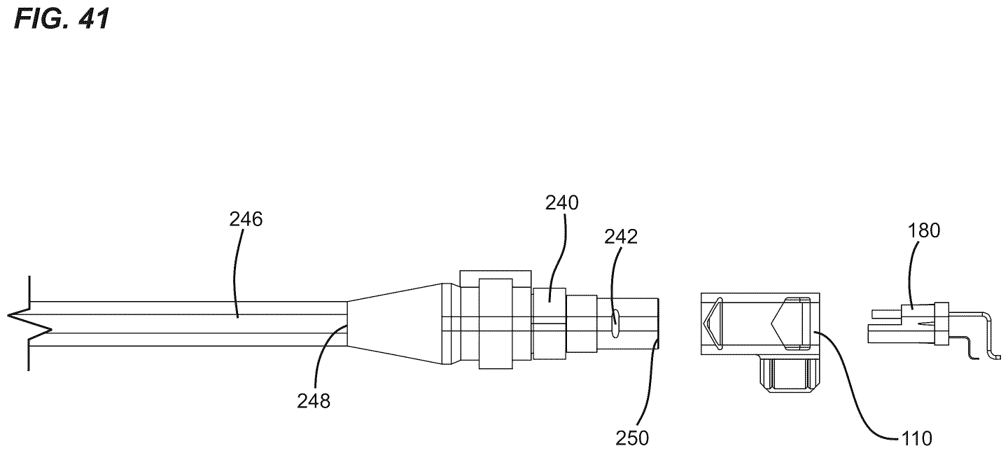

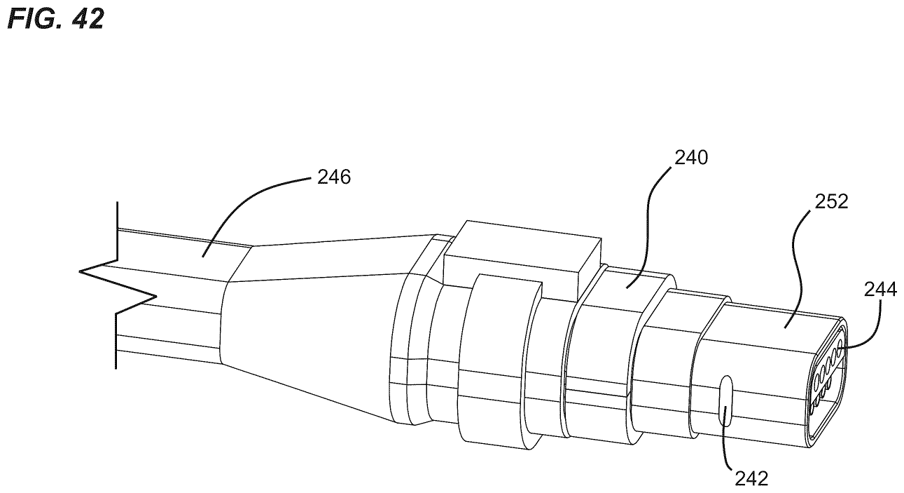

FIGS. 1-7 show an example connector 100 having a shell 110 and a contact block 180 positioned at least partially within the shell 110. The connector 100 is designed to receive a mating component, such as plug 240 (as shown in FIGS. 37-39 and 41). In certain examples, the connector 100 is designed to mount to a circuit board. The connector 100 may include a mounting fin 200 to attach the connector 100 to the circuit board. Each of these components will be discussed in turn.

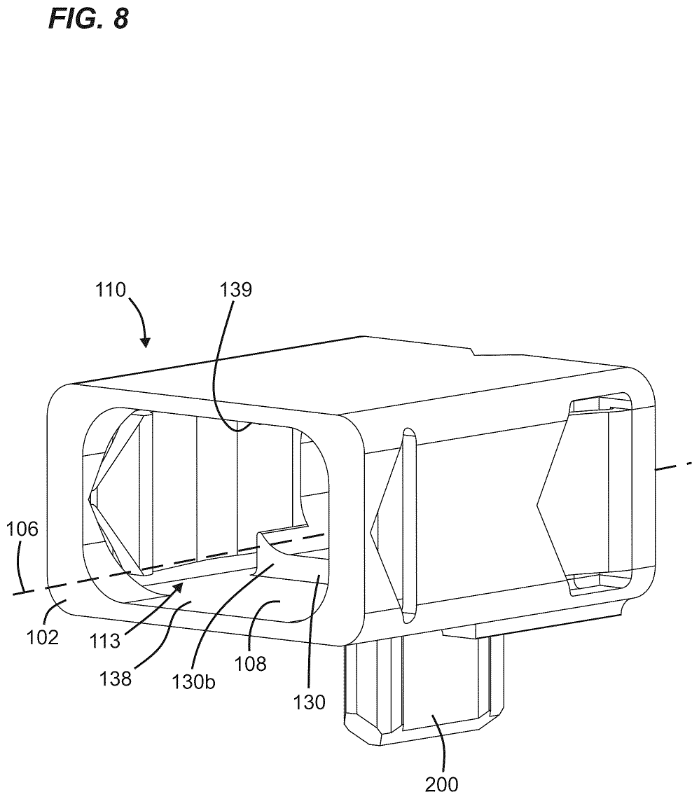

In certain examples, the shell 110 includes an opening 112 at a first end 102, and a channel 113 extending at least partially through the shell 110 from the opening 112. The opening 112 and channel 113 are designed for receiving a corresponding plug 240. A plug axis 106 is defined extending through the opening 112 and channel 113 from the first end 102 and centered about the opening 112. The plug axis 106 (seen in FIG. 8) defines an axis along which the plug 240 travels relative to the connector 100 when connecting to the connector 100. The channel 113 may also house at least a portion of the contact block 180. In certain examples, the contact block 180 may be inserted from the opening 112 at the first end 102. In certain examples, the channel 113 continues through the shell 110 from the opening 112 toward a second end 104 of the shell 110 such that an aperture 114 is formed in the shell 110 at the second end 104. In certain examples, the channel 113 extends along the plug axis 106 between the first and second ends 102, 104. In certain examples, the shell 110 has a length between the first and second ends 102, 104 that is between 0.2 and 0.3 inches.

In certain examples, the channel 113 includes a plug region 116 and a block region 118. In certain examples, the plug region 116 is a portion of the channel 113 extending inward from the opening 112 that the plug 240 would occupy when the plug 240 is attached to the connector 100. The plug region 116 may be sized to correspond to the size of the plug 240, such that the plug 240 forms a close fit within at least a portion of the plug region 116. The opening 112 at the first end 102 may form a close fit with an outer perimeter of the plug 240 such that the opening 112 at the first end 102 assists in orienting the plug 240 for insertion. In certain examples, the plug region 116 extends from the first end 102 to an intermediate distance within the opening 112.

In certain examples, the block region 118 is a portion of the channel 113 that the contact block 180 occupies when in an assembled position with the shell 110. The block region 118 may be sized to correspond to the size of the contact block 180, such that the contact block 180 forms a close fit within at least a portion of the block region 118. In certain examples, the block region 118 extends from the second end 104 and continues to an intermediate distance within the opening 112. The plug region 116 and the block region 118 therefore collectively form the channel 113 and may be considered to intersect and/or overlap at a location along the channel 113 where the plug 240 and the contact block 180 interact when mated together. Specifically, mating region 120 is located where the block region 118 and the plug region 116 overlap when in a connected state.

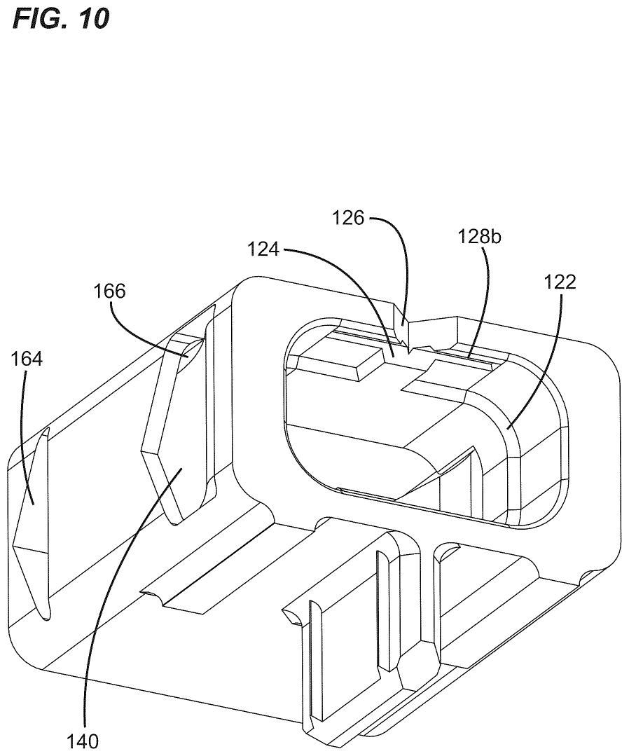

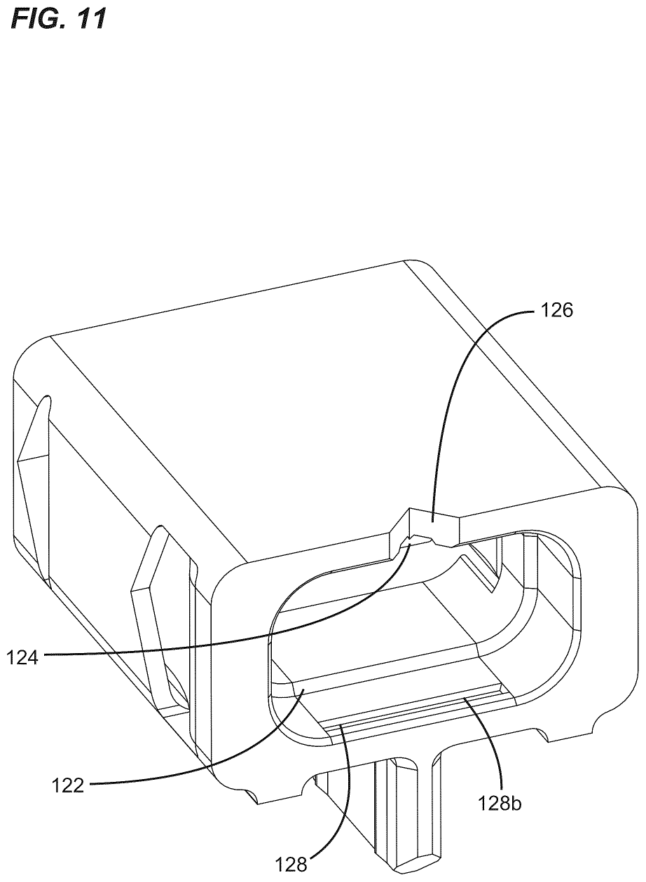

In certain examples, the shell 110 includes one or more block receiving features. In certain examples, the block receiving features position the contact block 180 such that the contact block 180 can properly interface with the plug 240 to form an electrical connection. In certain examples, the block receiving features assist with positioning of the contact block 180 within the block region 118, and can, in some instances, prevent over-insertion of the contact block 180, which might otherwise cause misalignment of a plug with engagement features (as discussed below) or damage electrical leads extending from the contact block. As shown in FIGS. 10-11, the shell 110 has a first block receiving feature 122 positioned within the channel 113 of the shell 110. The first block receiving feature 122 is positioned within the block region 118 of the opening 112. As shown, the first block receiving feature 122 forms a shoulder 123 extending about at least a portion of a perimeter of the opening 112 and the shoulder 123 extends radially inward from an interior opening surface 108 about the plug axis 106.

In certain examples, the shell 110 includes a second block receiving feature 124 positioned within the opening 112. As shown, the second block receiving feature 124 forms a shoulder 125 extending about at least a portion of the perimeter of the opening 112 and the shoulder 123 extends inward from the opening surface 108 about the plug axis 106. The second block receiving feature 124 extends from the first block receiving feature 122 about the plug axis 106 and toward the second end 104. The second block receiving feature 124 has a shoulder height that is the same as the first block receiving feature 122.

In certain examples, the shell 110 includes a third block receiving feature 126. As shown in FIGS. 10-11, the third block receiving feature 126 is formed on an exterior 132 of the shell 110. The third block receiving feature 126 forms a notch extending from the second end 104 toward the first end 102. The notch also extends between a top exterior surface 134 of the shell 110 and the opening surface 108 of the opening 112. The block receiving features 122, 124, 126 are designed to interface with corresponding features of the contact block 180, as can be seen in FIG. 43.

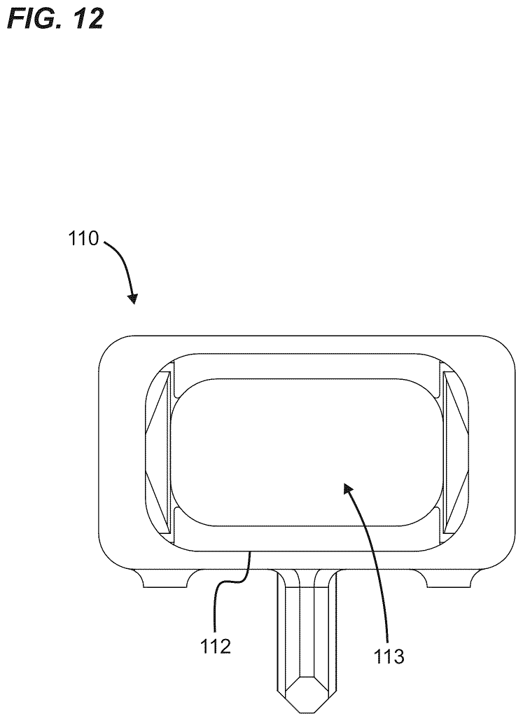

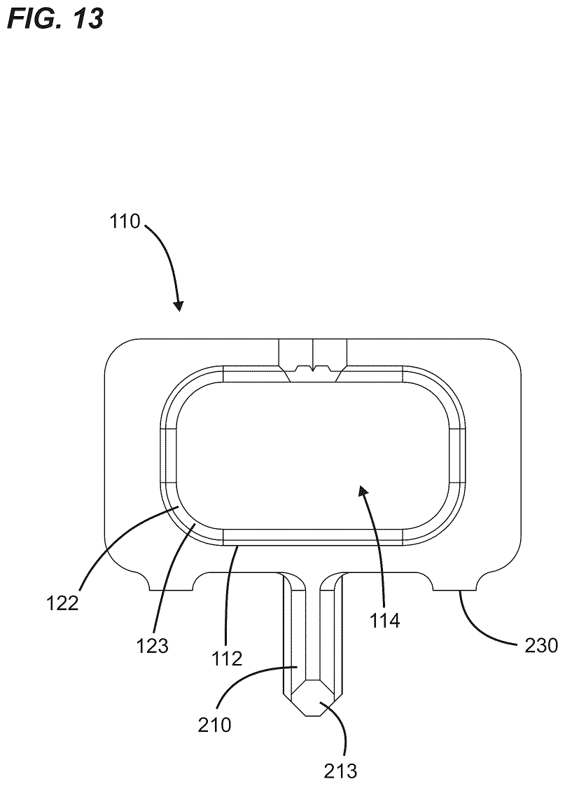

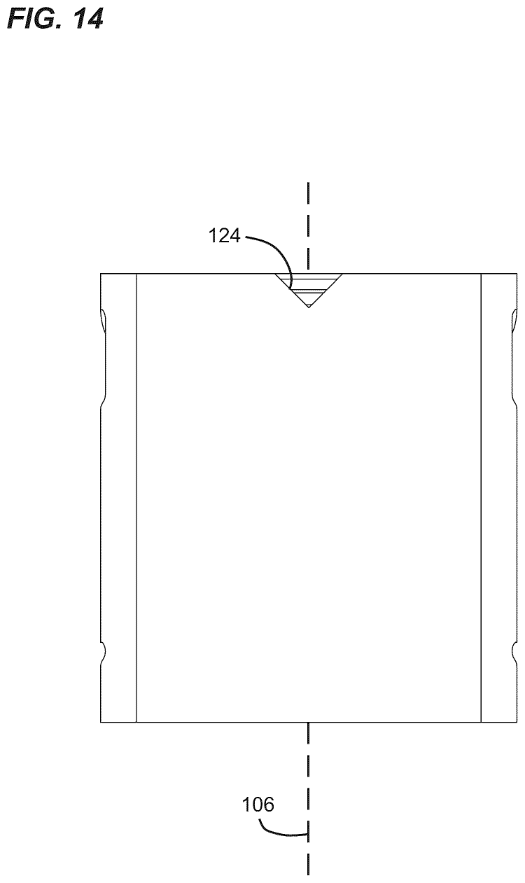

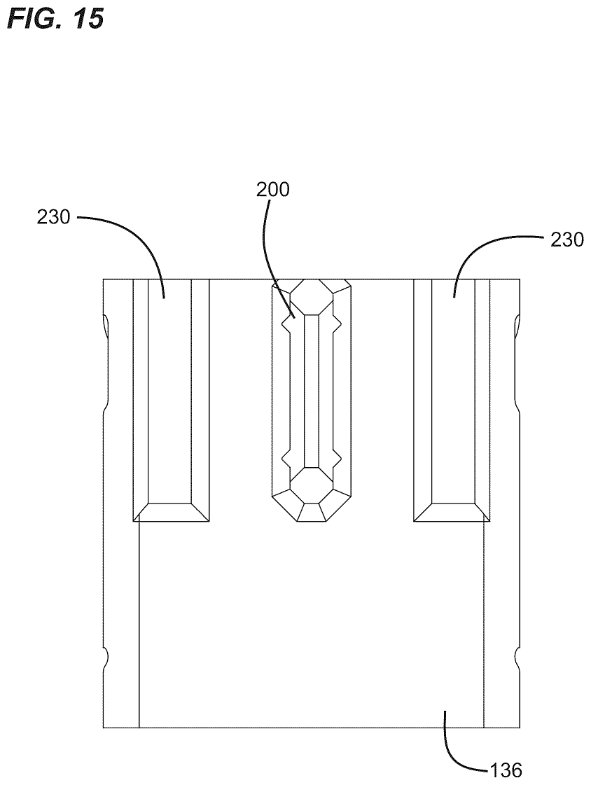

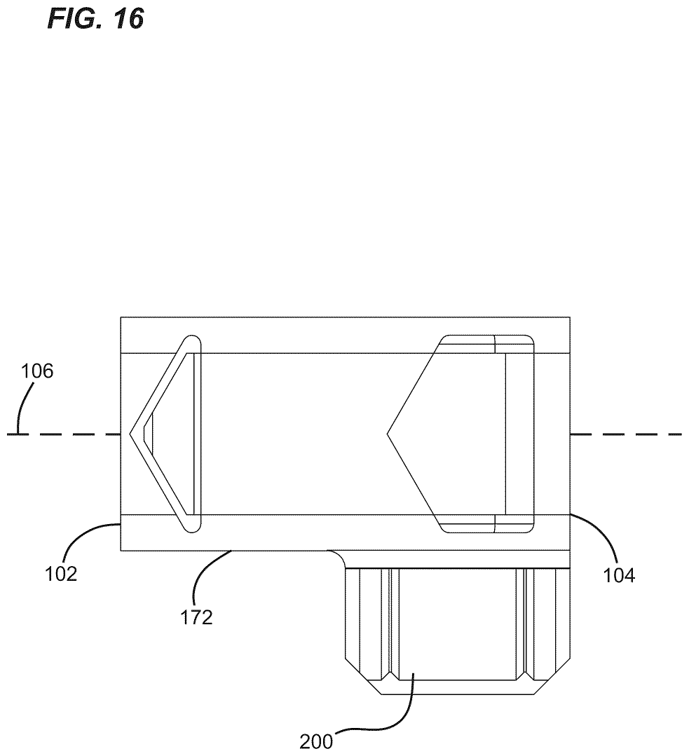

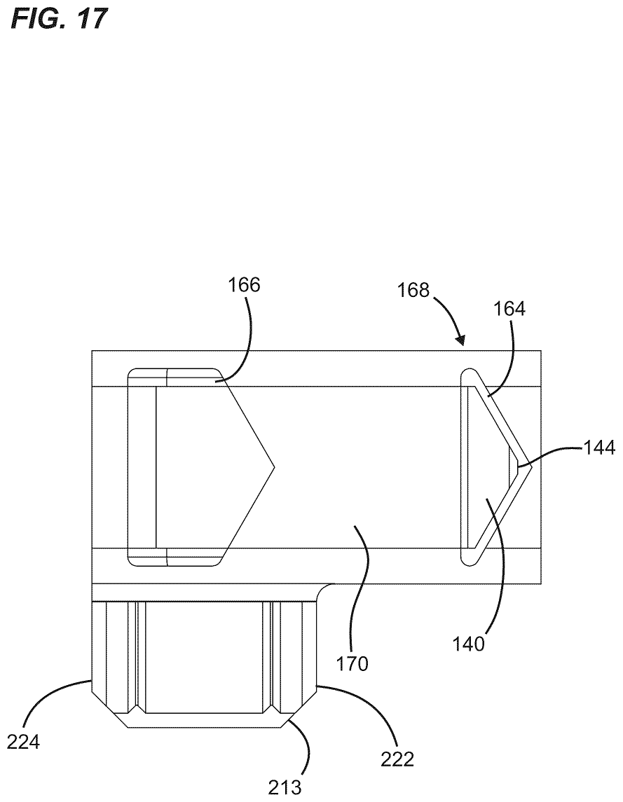

The shell 110 may also include one or more block retaining features 128. The block retaining features 128 may have any number of designs sufficient to maintain connection between the shell 110 and the contact block 180. For example, the block retaining feature 128 may be a latch, a protrusion, or a channel. As shown in FIGS. 1-17, the shell 110 includes two block retaining features 128. First and second block retaining feature 128a, 128b each form a channel designed to contain a corresponding retaining feature on the contact block 180. The channel includes a first shoulder that interacts with the contact block 180 during insertion and removal of the contact block 180. The interaction may be an interference between the shell 110 and the contact block 180. The first block retaining feature 128a is positioned about the upper opening surface 139 in the block region 118. The second block retaining feature 128b is positioned about the lower opening surface 138 in the block region 118.

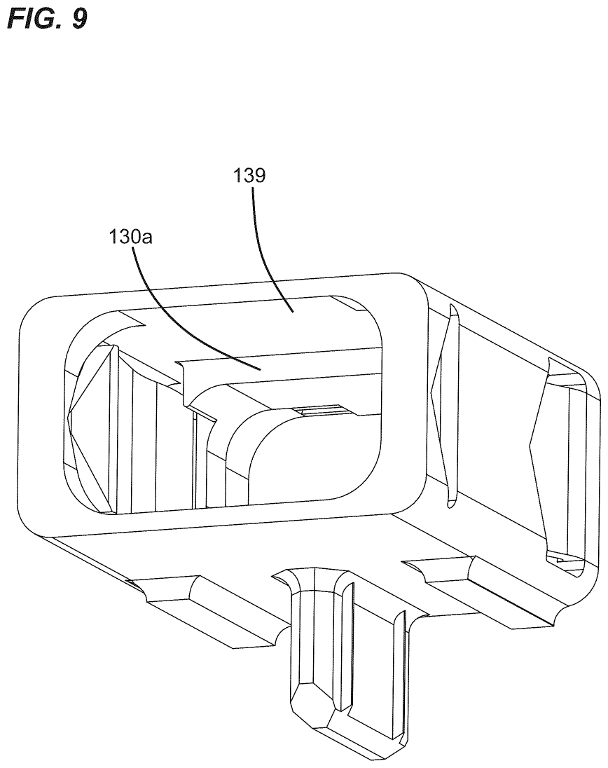

In certain examples, the shell 110 includes plug receiving features. In certain examples, the plug receiving features position the plug 240 such that the plug 240 can properly interface with the contact block 180 to form an electrical connection. In certain examples, the plug receiving features prevent over-insertion of the plug 240. As shown in FIGS. 8-9, the shell 110 has a first plug receiving feature 130 positioned within the channel 113 of the shell 110. The first plug receiving feature 130 is positioned within the plug region 116 of the channel 113 and within the mating region 120 as the contact block 180 extends into the plug 240. As shown, the first plug receiving feature 130 forms an upper shoulder 130a and a lower shoulder 130b each extending about at least a portion of a perimeter of the channel 113, and the shoulders 130a, 130b extend radially inward from the opening surface 108 about the plug axis 106. The upper shoulder 130a extends along an upper opening surface 139 of the channel 113. The lower shoulder 130b extends along a lower opening surface 138 of the channel 113. The upper shoulder 130a may extend from the first block receiving portion 122 toward the first end 102. The lower shoulder 130b may extend from the first block receiving portion 122 toward the first end 102.

In certain examples, the shell 110 includes a pair of latch arms 140 that are configured to retain the plug 240. In certain examples, each of the two latch arms 140 are structurally the same. In certain examples, the latch arms 140 extend from an anchor 142 and terminate at a tip 144. The anchor 142 defines a region where the latch arm 140 connects to a main body of the shell 110. The tip 144 defines a free end of the latch arm 140. The latch arm 140 has a length L that extends between the anchor 142 and the tip 144. In certain examples, the length L extends from the anchor 142 toward the first end 102. In certain examples, the length L is between 0.21 and 0.22 inches. In certain examples, the latch arms 140 extend from the anchor 142 toward the first end 102 within the opening 112. The shape of the latch arm 140 may vary about the length L. In certain examples, the latch arm 140 includes an exterior side 146 and an interior side 148, where the exterior side 146 faces towards the exterior surface of the shell 110 and the interior side 148 faces toward the opening 112 of the shell 110. The exterior side 146 and interior side 148 of the latch arm 140 form parallel surfaces about a majority of the length of the latch arm 140. In certain examples, the anchor 142 includes a filleted inside edge and a straight outside surface that continues to the exterior surface 132 of the shell 110.

In the example shown in FIG. 33, both the exterior side 146 and the interior side 148 of the latch arm 140 are flat with a curved surface. In certain examples, the curved surface is alternating. For example, the curved surface may be sinusoidal, oscillating, alternating, or undulating, etc., as it extends about the length L. As the latch arm 140 extends from the anchor 142, the latch arm 140 has a first inwardly-oriented section 149, followed by a first outwardly-oriented section 150, followed again by a second inwardly-oriented section 151, and finally a second outwardly-oriented section 152 that terminates at the tip 144. The inwardly-oriented sections 149, 151 curve toward the opening 112 and the outwardly-oriented sections 150, 152 curve toward the exterior surface 132 of the shell 110. The transition between the first inwardly-oriented section 149 and the first outwardly-oriented section 150 forms a first inward apex 153. The transition between the first outwardly-oriented section 150 and the second inwardly-oriented section 151 forms a first outward apex 154. The transition between the second inwardly-oriented section 151 and the second outwardly-oriented section 152 forms a second inward apex 155.

The latch arm 140 includes a retaining feature 156. In certain examples, the retaining feature 156 is a protrusion or bump at an intermediate position about the length L of the latch arm 140. In the example shown, the retaining feature 156 is positioned at a distance L1 from the anchor, where L1 is shorter than the length L. As shown in FIG. 33, the retaining feature 156 is a bump on the interior side 148 of the latch arm 140 adjacent to and forming the second inward apex 155 on the interior side 148. The retaining feature 156 forms a stepped transition 158 nearest the anchor 142 and a smooth transition to the tip 144. The stepped transition 158 between the second inwardly-oriented section 151 and the bump provides a retention surface. The shape of the retaining feature 156 and the interaction with a corresponding retention feature 242 of the plug 240 can increase or decrease the retention of the plug 240.

The first outward apex 154 is part of a contact region 160. The contact region 160 defines a portion of the latch arm 140 at an intermediate length about the latch arm 140 that contacts a contact portion 162 of the shell 110 when the latch arm 140 is sufficiently flexed outwardly, for example by at least a partial insertion of a mating component, like the plug 240. In the example shown, the contact region 160 is positioned at a length L2 from anchor 142, where the distance L2 is shorter than the distance L1. In certain examples, the contact portion 162 is an interior surface of a sidewall 170 of the shell 110, defining a portion of the opening 112. The sidewall 170 extends between upper and lower portions of the shell 110. The contact portion 162 is designed to have sufficient strength such that the latch arm 140 deflects when the contact region 160 engages the contact portion 162, with negligible deflection of the sidewall 170.

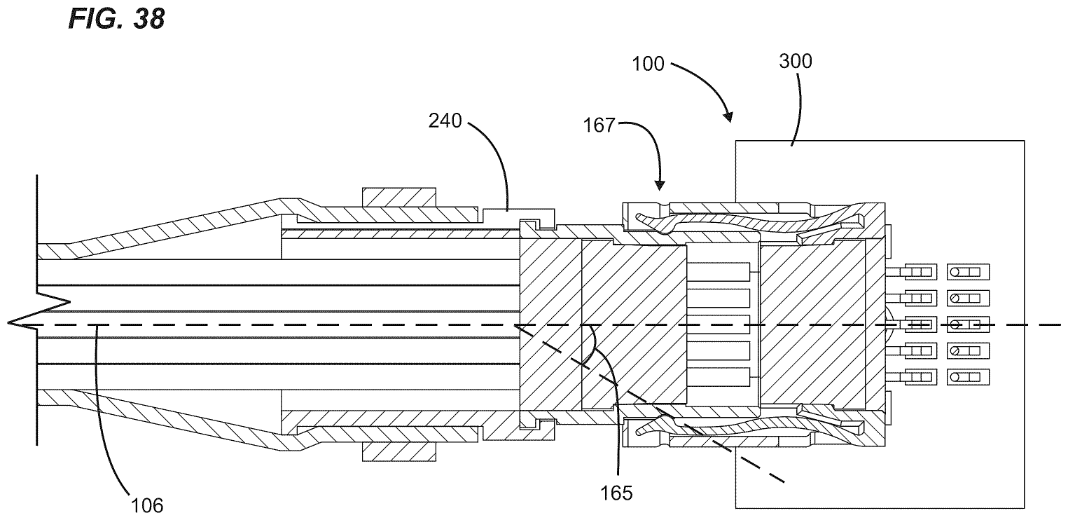

In certain examples, shown best in FIG. 38, an engagement angle 165 is defined between the retaining feature 156 and the contact portion 162 of the shell 110 relative to the plug axis 106 when the latch arm 140 is in an engaged position 167. The latch arm 140 is in the engaged position 167 when a mating component, such as the plug 240, is seated in the connector 100. The latch arm 140 flexes during insertion and removal of a mating component. While the entire latch arm 140 is constructed from a resilient, semi-flexible material, the first and second flex positions, at the anchor 142 and the contact region 160, define the locations that are constrained during flexure, as further described herein.

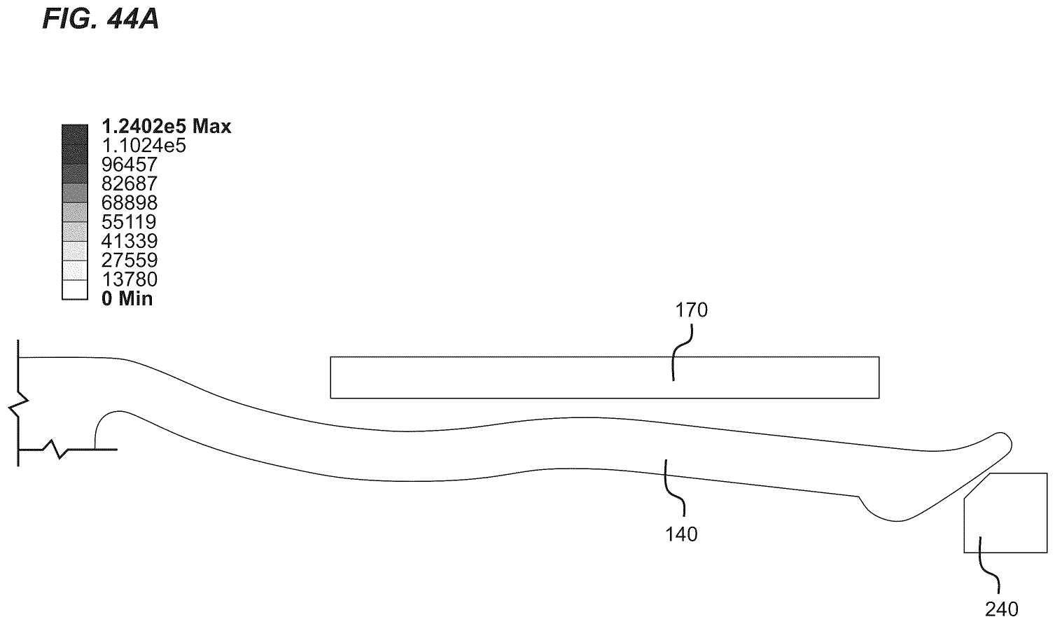

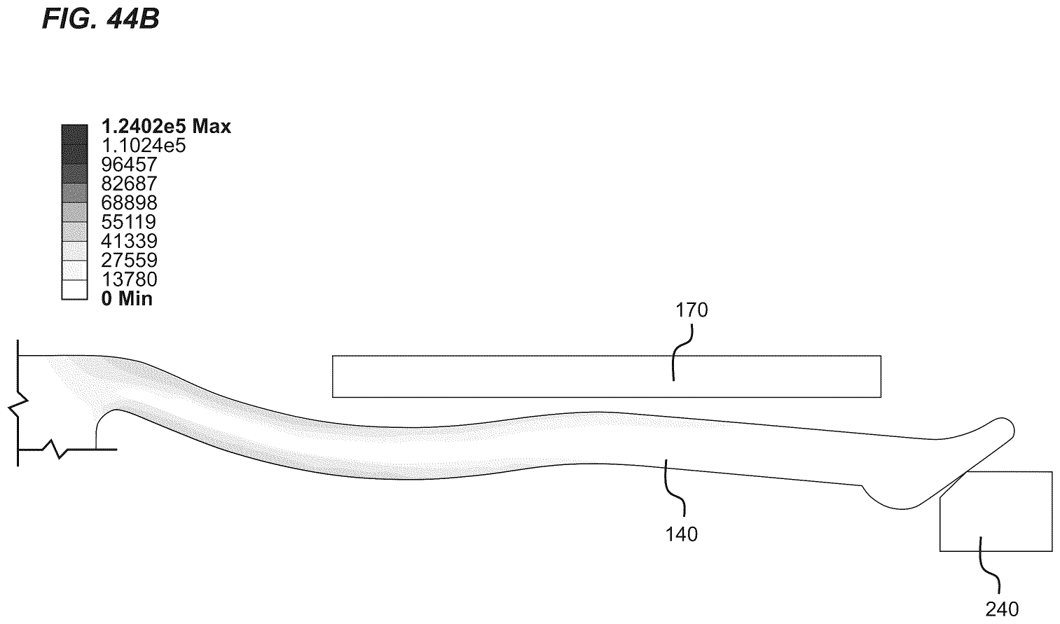

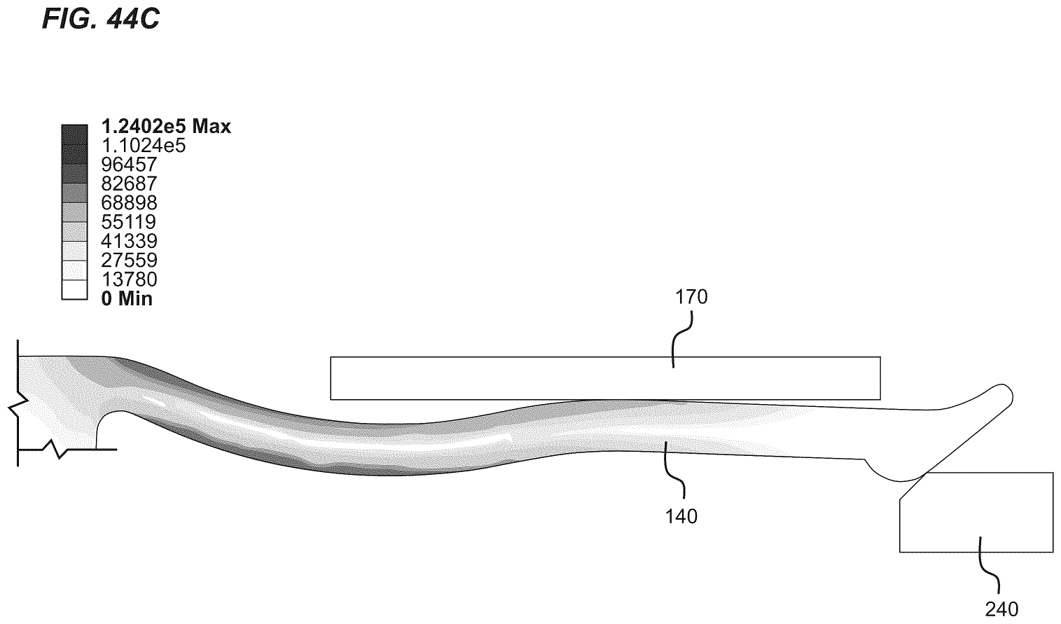

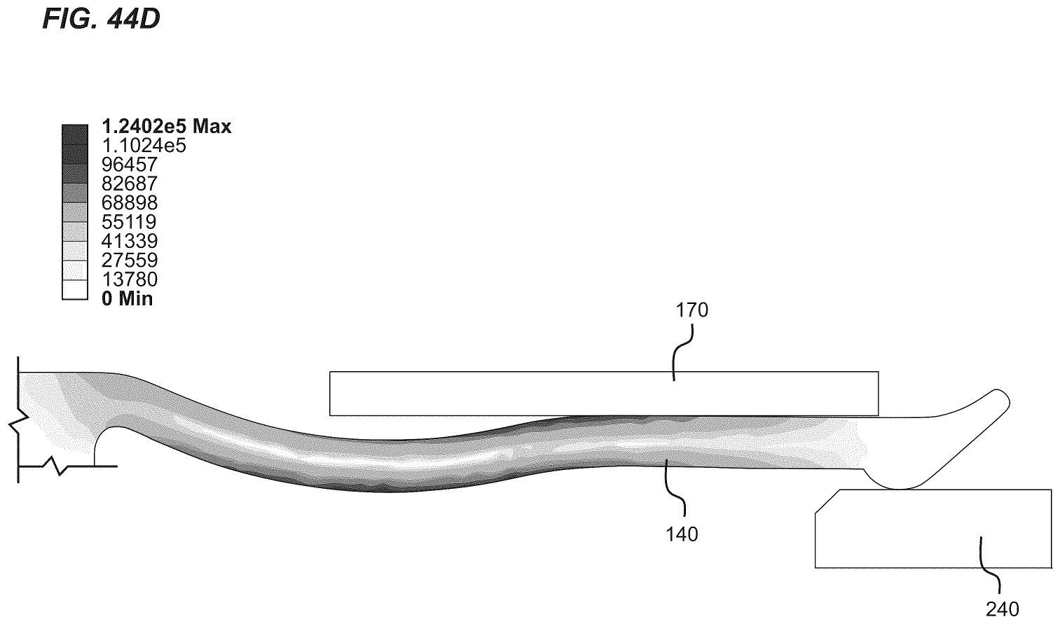

When no plug 240 is present, the latch arms 140 are in a neutral position 161 as shown in FIG. 33. As a plug is inserted, for example during an insertion process, the latch arm 140 may resiliently flex such that the retaining feature 156 and tip 144 move generally outwardly, e.g., toward the interior surface of the sidewall 170. This insertion process generally includes two phases. In a first phase, a flexing movement and resulting stress is concentrated in a portion of the length of the latch arm proximate to and extending from the anchor 142 (described further below, in conjunction with FIG. 44B). This first phase of the flexing movement occurs prior to the contact region 160 contacting the contact portion 162. Once the latch arm 140 is flexed from a default position (shown in FIG. 44A) it may reach a first flex position (shown in FIG. 44C), in which the tip is deflected a partial distance toward the sidewall 170 and the contact region 160 reaches initial contact with the contact portion 162. At this phase, the retaining feature 156 and tip 144 may be further deflected outwardly (e.g., until the position shown in FIG. 44D in which the retaining feature 156 is positioned adjacent sidewall 170 and tip 144 extends at least partially into or through a first side opening 164 described below); in this phase, a greater amount of flexing stress will be imparted to a portion of the latch arm 140 from the contact region 160 and extending toward the retaining feature 156 and tip 144 (compare FIG. 44C and FIG. 44D). This has the effect of greater dispersion of flexing force along the latch arm 140, as well as improved retention force at the retaining feature 156.

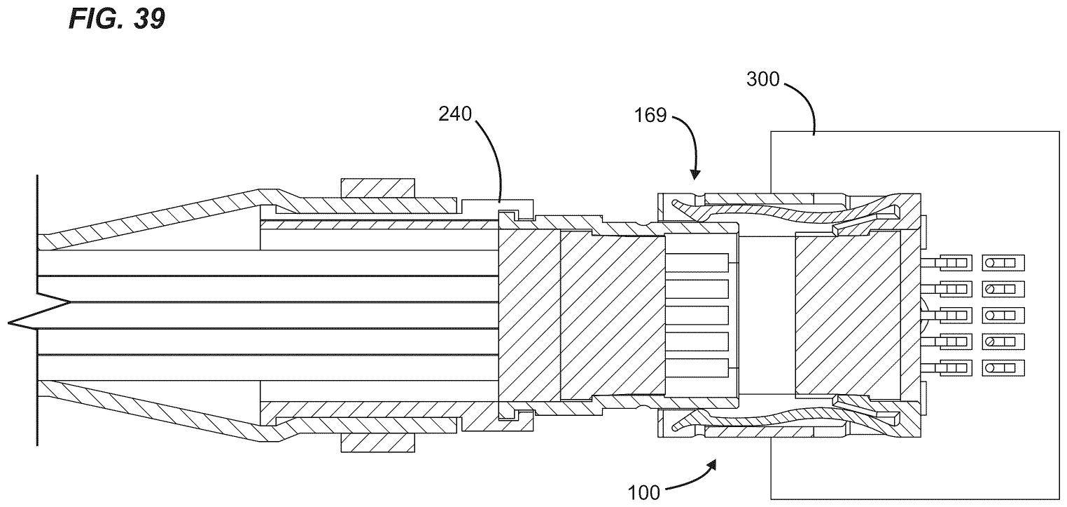

Referring back to FIG. 38, because the latch arm 140 flexes about the contact region 160 during the second phase of flexing movement, the engagement angle 165 is greater than if the latch arm 140 only flexed about the anchor 142. By increasing the engagement angle 165, the engagement force provided by the latch arm 140 is increased because more of the force is directed normal to the plug axis 106. Further, by shortening a length between the retaining feature 156 and the next flex position, in this case the second flex position, the effective lever arm length is decreased which results in needing a greater force to produce an equivalent torque at the second flex position. An example insertion process, such as described above, is shown in FIGS. 38-39. As described above, the result of having two flexing phases results in a stiffer latch arm with greater retention force relative to a single flex position latch arm. Further, the peak stress created along the latch arm is reduced because the stress is distributed more evenly across the latch arm 140, as opposed to being concentrated at the anchor 142 which may occur in the absence of limiting flex at the point where contact region 160 contacts the contact portion 162. As noted above, an example illustration of the stress distribution is shown in FIGS. 44A-44D and is discussed in greater detail below.

In certain examples, the tip 144 is at the end of the second outwardly-oriented section 152 such that during insertion of a mating component, the tip 144 moves toward the exterior surface 132 of the shell 110. In certain examples, the tip 144 is recessed behind the opening 112 at the first end 104 as viewed about the plug axis 106 from the first end 102 such that the tip 144 does not interfere with insertion of the plug 240. The second outwardly-oriented section 152 provides a first contact surface for an incoming plug 240 that allows for consistent engagement and flexing of the pair of latch arms 140. In certain examples, the recessed tip 144 may also help to prevent damage to the latch arm 140 during insertion of the plug 240. The latch arm 140 is designed for flexing normal to the plug axis 106, but may be susceptible to damage when forces are applied to the tip 144 about the plug axis 106.

In certain examples, a first side opening 164 is formed around a tip region 168 of the shell 110 where the tip 144 extends towards the exterior 132 of the shell 110. The first side opening 164 extends between the opening surface 108 and the exterior 132 of the shell 110. The first side opening 164 provides clearance for the tip 144 when the latch arm 140 is flexed in an insertion position 169. In certain examples, the first side opening 164 also provides clearance for the tip 144 when the latch arm 140 is flexed in the engaged position 167. The first side opening 164 may be any shape suitable to provide clearance. In certain examples, the first side opening 164 forms a triangular opening to align with a taper in the latch arm 140 as the latch arm 140 transitions from the retaining feature 156 to the tip 144.

In certain examples, the anchor 142 of the latch arm 140 forms a portion of the exterior 132 of the shell 110. The latch arm 140 continues into the channel 113 of the shell 110 toward opening 112. As a portion of the latch arm 140 proximate the anchor extends toward the opening 112, it extends inwardly within the shell 110 relative to sidewall 170, forming a second side opening 166 where the latch arm 140 (e.g., at first inwardly-oriented section 149) curves inward into the channel 113. The second side opening 166 is positioned nearer the anchor 142 than the first side opening 164.

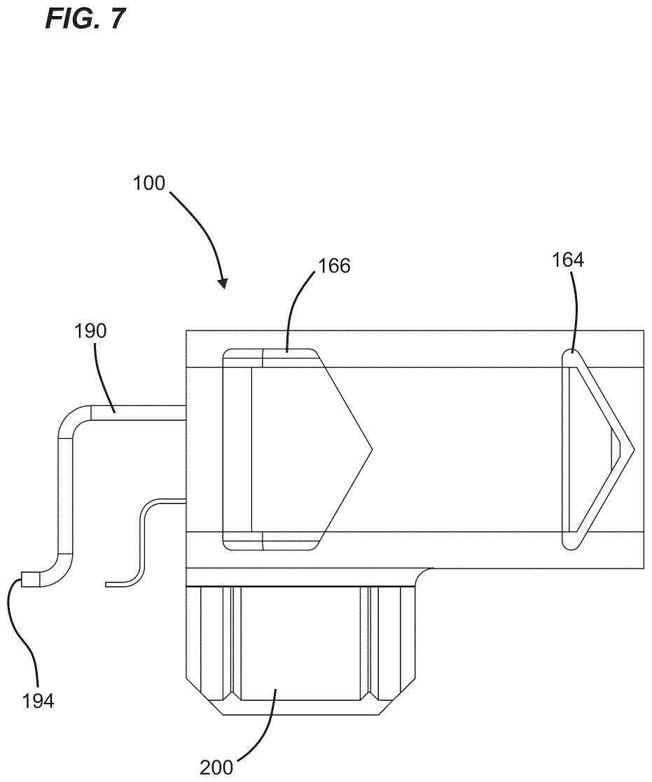

In example arrangements, the second side opening 166 enables the latch arm 140 to move freely while minimizing the space occupied by the anchor 142 and latch arm 140 within the interior of the connector 100. For example, if the latch arm 140 were not anchored at the exterior 132 of the shell 110, more space would need to be occupied within the channel 113 for the latch arm 140 to function. By having the anchor 142 of the latch arm 140 on an exterior 132 of the shell 110, the footprint of the connector 100 is reduced. The second side opening 166 may be any suitable shape. The second side opening 166 need only provide clearance for the latch arm 140 to extend freely away from the anchor 142 such that the latch arm 140 is able to flex. As shown in FIG. 7, the second side opening 166 is an irregular pentagon shape. The examples shown in FIGS. 1-17, include the first and second side openings 164, 166 on each side of the shell 110 to correspond with the pair of latch arms 140. In certain examples, the latch arm 140 is integrally connected to or formed with the shell 110.

In certain examples, a latch space 171 is formed between the latch arm 140 and an exterior facing side of the plug and block receiving features within the opening 112. The latch space 171 provides clearance for the first inwardly-oriented section 149 to direct the latch arm 140 from the exterior surface 132 into the channel 113.

In certain examples, a bottom exterior surface 136 of the shell 110 includes a mounting fin 200. The mounting fin 200 is designed to engage a printed circuit board (“PCB”) 300. In certain examples, the mounting fin 200 is designed to accurately locate the connector 100 to the PCB 300 and provide sufficient space between the mounting fin 200 and a side 302 of a PCB slot 304 such that an adequate solder joint can be formed (e.g., solder may form along the sides of the mounting fin 200 when positioned within a slot of the PCB 300). In certain examples, the mounting fin 200 extends away from a main body 172 of the shell 110 in a direction normal to the plug axis 106, e.g., in a first direction 214. In certain examples, the mounting fin 200 includes a first side 202 and a second side 204. Each side 202, 204 has a rectangular shape 206 with a flat portion 208 extending between tapered edges 210 of the rectangular shape 206. In certain examples, each side 202, 204 also includes one or more ridges, shown as a plurality of ridges 212, extending in the first direction 214 along at least a portion of the mounting fin 200.

In certain examples, the plurality of ridges 212 extend a distance outward from and normal to the flat portion 208. The height of the plurality of ridges 212 is sufficient to create an adequate solder joint. In certain examples, the height of the plurality of ridges 212 ranges between 0.002 and 0.006 inches in height. As shown in FIGS. 1-17, the mounting fin 200 includes two ridges 212 extending from a base 216 of the mounting fin 200 and continuing to an opposing edge of the flat portion 208. A solder channel 220 is formed between neighboring ridges 212 with a subset of the flat portion 208 extending between the ridges 212 and forming a base of the solder channel 220. As shown, outermost corners 213 of the mounting fin 200 are also tapered. The tapering provides improved positioning of the mounting fin 200 into the PCB slot 304. The ridges 212 ensure that the connector 100 is accurately positioned within the PCB slot 304. The solder channel 220 provides a gap 218 between the mounting fin 200 and the PCB 300 for solder to go. A peak of the plurality of ridges 212 is designed to form a tight fit with the PCB slot 304 such that a width between a peak of a ridge on the first side and a peak of a corresponding ridge on the second side is a tight fit with a width of the PCB slot 304. In certain examples, the fit is an interference fit.

In certain examples, the mounting fin 200 has a length about the plug axis 106 that extends between a first fin end 222 and a second fin end 224. In certain examples, the second end 104 of the shell 110 is flush with the second end 224 of the mounting fin 200. In certain examples, the mounting fin 200 has a length between 0.1 and 0.2 inches between the first fin end 222 and the second fin end 224. In certain examples, the length of the mounting fin 200 between the first and second fin ends 222, 224 is about half a length of the shell 110 between the first and second ends 102, 104. In certain examples, the length between the first and second fin ends 222, 224 is between 25% and 75% a length of the shell 110 between the first and second ends 102, 104. In certain examples, the mounting fin needs a minimum length between first and second fin ends 222, 224 in order to maintain secure contact with the PCB 300 and provide sufficient solder contact. In certain examples, the length between first and second fin ends 222, 224 is between 0.1 and 0.15 inches.

In certain examples, stabilizing pads 230 are also present at the bottom exterior surface 136 of the shell 110. The stabilizing pads 230 provide stabilization for the connector 100 when attached to the PCB 300 such that side-to-side movement does not cause the connector 100 to become detached or overly stress the solder. The stabilizing pads 230 may be integral to the shell 110. In certain examples, the stabilizing pads 230 are secured to the PCB 300 using surface mount technology such that the stabilizing pads 230 are soldered to the PCB 300. In certain examples, the stabilizing pads 230 are soldered to the PCB before the mounting fin 200. Soldering the stabilizing pads 230 prior to the mounting fin 200, enables a simplified solder process for the mounting fin 200. In certain examples, the stabilizing pads 230 are soldered using a higher temperature solder than the solder used on the mounting fin 200 in order to prevent unsoldering the stabilizing pads 230 when soldering the mounting fin 200.

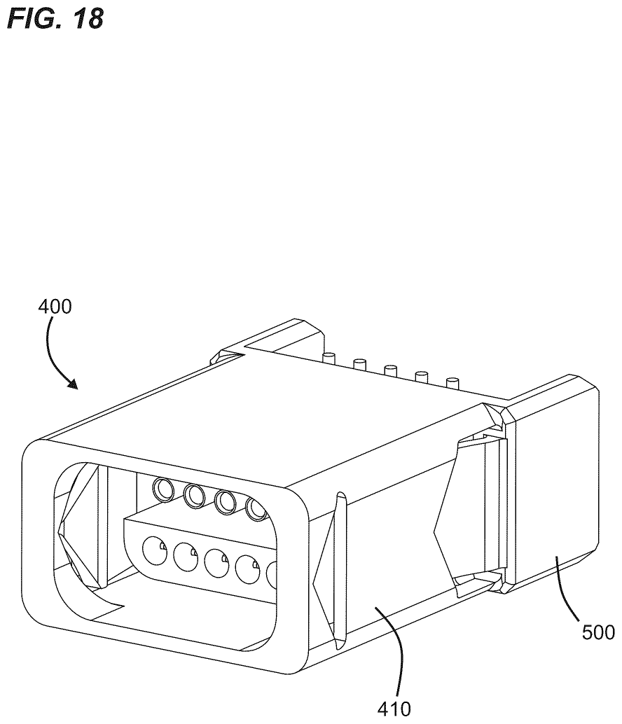

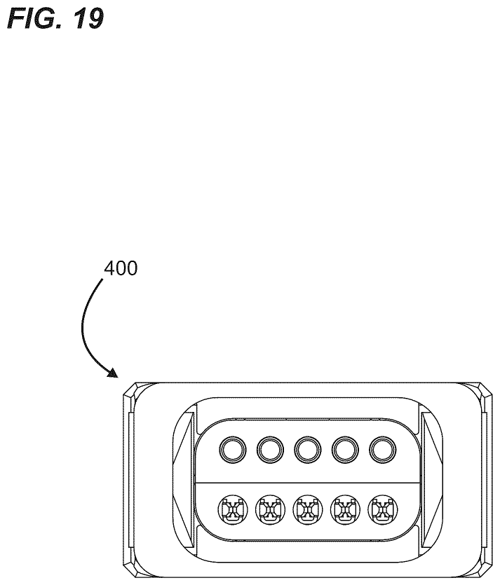

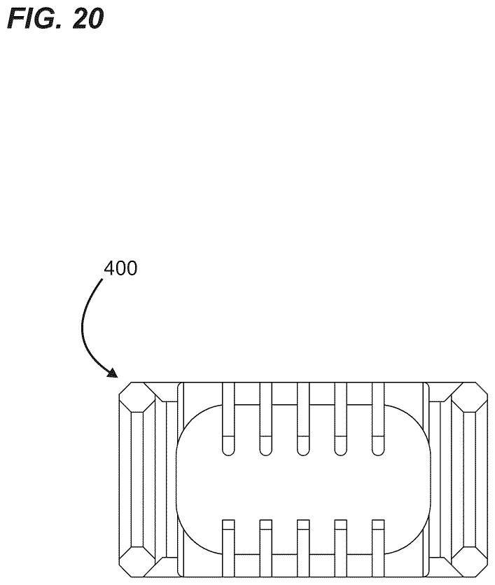

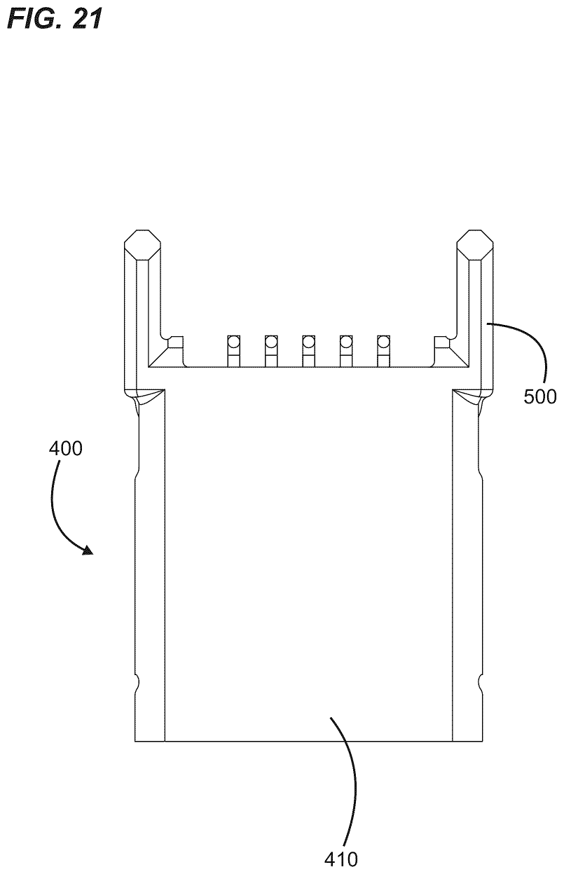

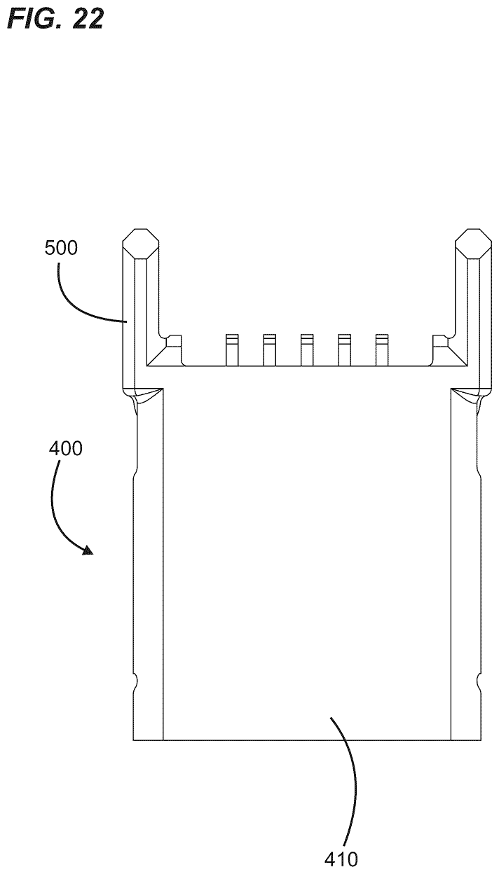

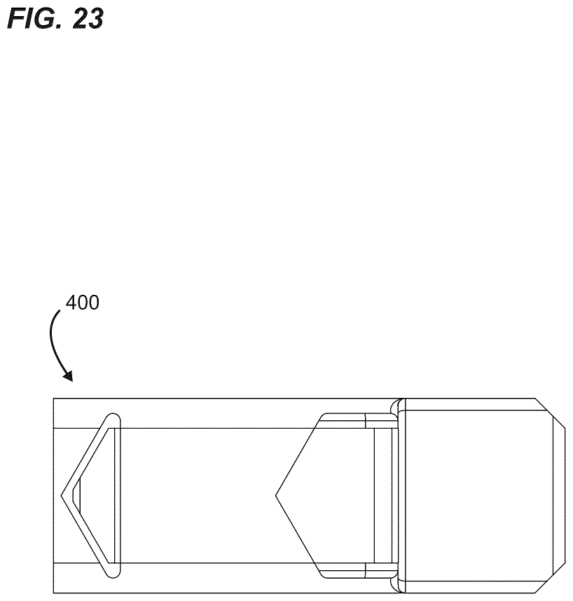

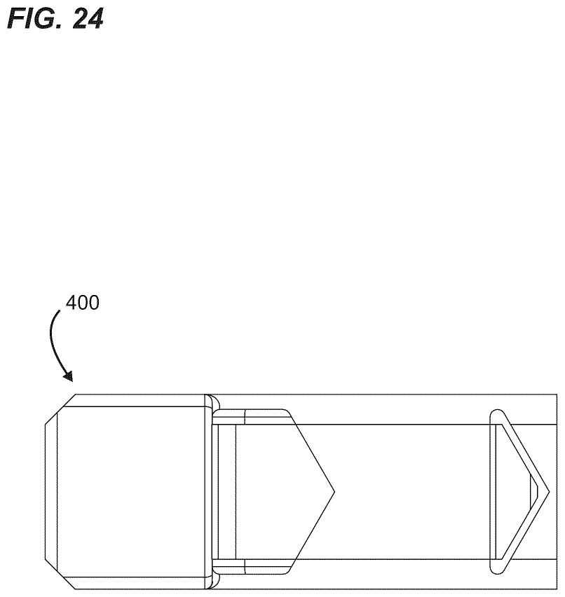

FIGS. 18-24 show another example connector 400 that shares many of the same features and inventive concepts of the connector 100. For conciseness, these features are not repeated, however, it should be noted that at least the features within the opening 112 including the latch arm 140 are the same between connector 100 and connector 400. Relevant differences are described below. The connector 400 includes a shell 410 and a pair of mounting fins 500. The connector 400 is designed to mount to a PCB 600 such that a plug axis 406 extends normal to a PCB surface 610. Conversely the connector 100 includes a mounting fin 200 which connects to the PCB 300 such that the plug axis 106 is parallel with a PCB surface 310.

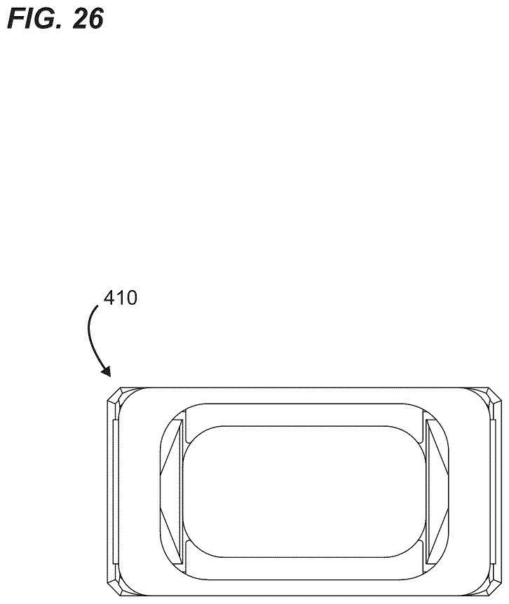

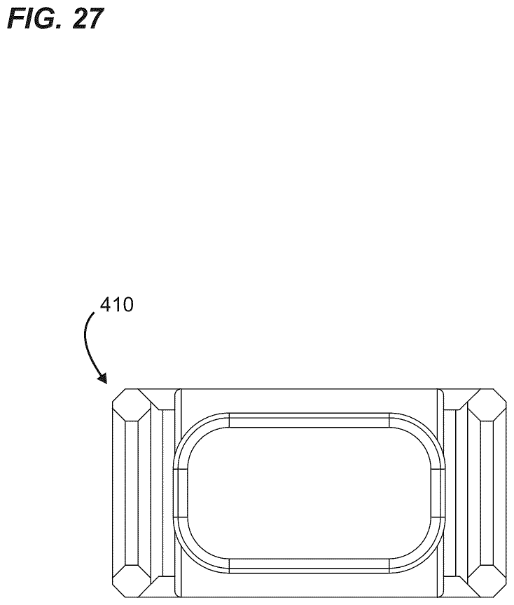

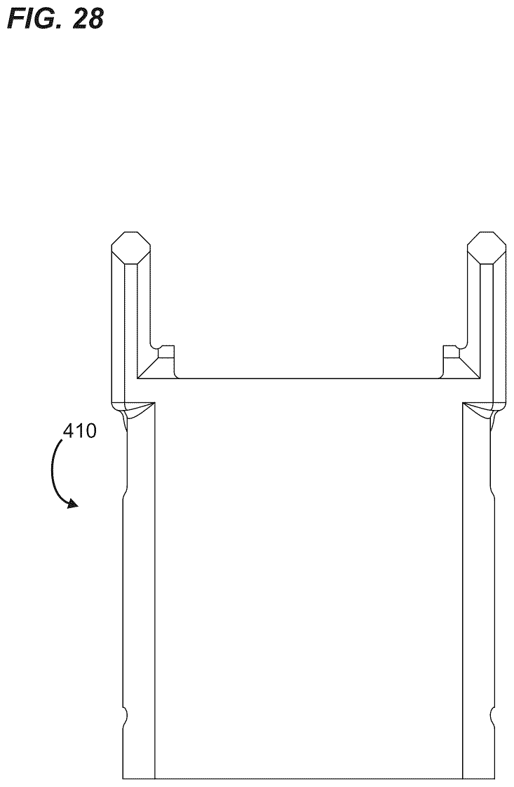

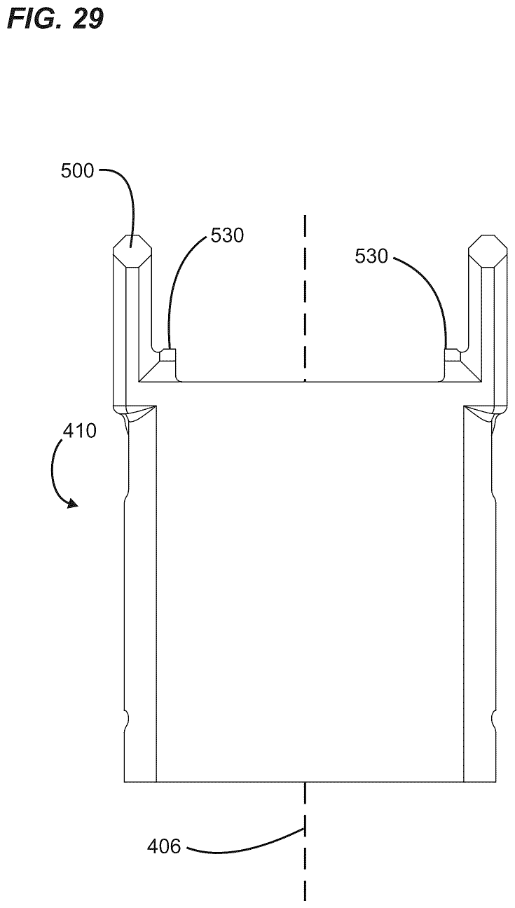

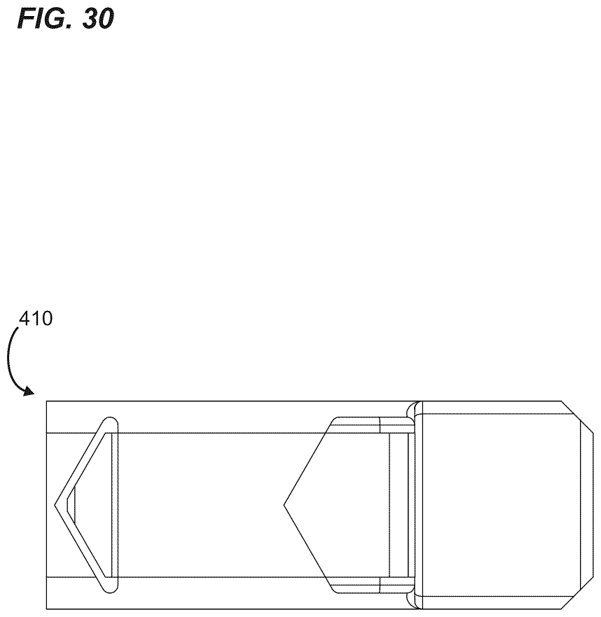

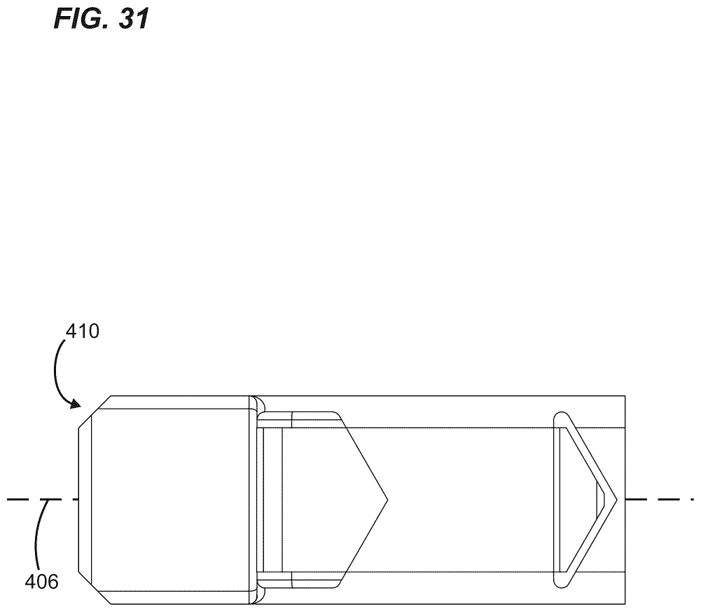

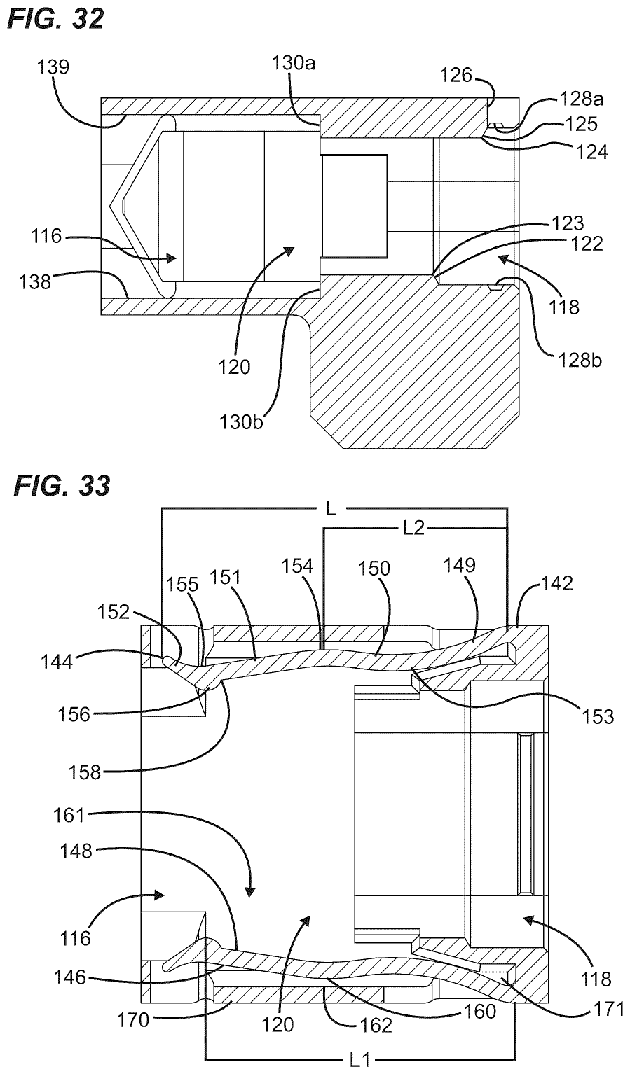

The shell 410 includes a pair of mounting fins 500. In certain examples, the mounting fins 500 include ridges which share the same features and function as ridges 212. In other examples, the mounting fins 500 do not include ridges. FIGS. 26-31 show an example shell 410 without ridges. The shell 410 may also include stabilizing pads 530. The stabilizing pads 530 may be spaced between the pair of mounting fins 500.

The use of tapers and fillets may be used throughout the shells 110, 410 in order to improve performance and/or simplify manufacturing. For instance, there may be a filleted edge between the main body 172 of the shell and the mounting fin 200. There may also be filleted edges defining portions of the opening 112.

Shells 110 and 410 may be made from a variety of different materials. In certain examples, the shells 110, 410 are made from metal. In certain examples, the entirety of the shell 110, 410 is made as an integral, unitary component. In certain examples, the entirety of the shell 110, 410 is made from stainless steel as an integral unitary component. In such instances, the shell 110, 410 may provide some electromagnetic shielding of the connection block 110 and plug 240 when inserted therein, in addition to advantages relating to resilience and physical compactness.

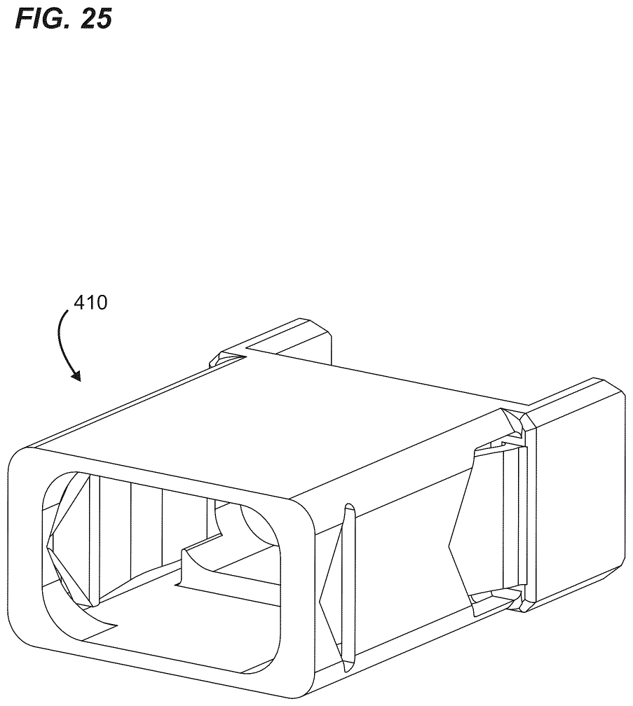

In the example shown in FIGS. 8-17 and 25-31, the shells 110, 410 are made integrally, such that the latch arms 140 and the mounting fins 200, 500 are integral to the shell 110, 410. Previous manufacturing limitations would have prevented an integral shell design having a latch design such as shell 110 with latch arm 140. Traditional methods for producing connector housings or shells involved various molding and machining processes. However molding processes have limitations in the design of certain components because the part must be removable from the mold. Similarly, machining processes have limitations because the machined surfaces must be accessible. These restrictions are magnified when component dimensions become very small, such as with compact electrical connectors. Conversely, additive manufacturing techniques such as stereolithography, fused deposition modeling, selective laser sintering, direct metal laser sintering, etc. enable more complex designs. In certain examples, the shells 110, 410 are made from additive manufacturing processes in order to form the complex geometries associated with the shell 110. Compact designs present even greater difficulty for traditional manufacturing techniques. In certain examples, the shell 110 is around 0.25 inches long and less than 0.25 inches wide. In certain examples, individual features within the shell 110 are manufactured with tolerances of less than 0.002 inches. In certain examples, the shell 110, 410 is made from an additive manufacturing process from stainless steel in order to enable various design features in a compact connector design having a footprint of less than 0.25×0.25 inches that would otherwise not be possible to produce. These features include, for example, the latch arms 140 and mounting fin ridges 212.

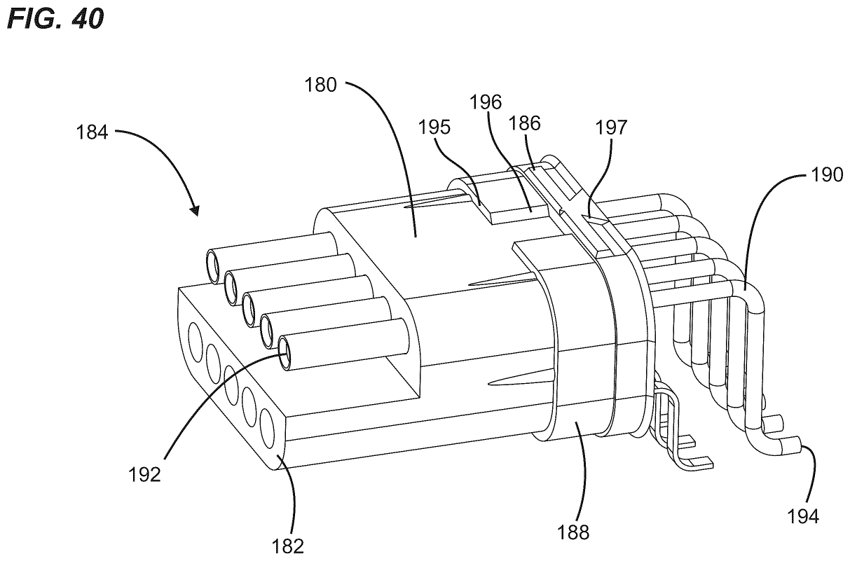

In certain examples, the contact block 180 fits at least partially into shells 110, 410. The contact block 180 is designed to have one or more receiving features that correspond with the block receiving features 122, 124, and 126 of the shell 110 such that the contact block 180 can be properly positioned within the channel 113 of the shell 110. In certain examples, shell receiving feature 195 corresponds to block receiving feature 122. In certain examples, shell receiving feature 196 corresponds to block receiving feature 124. In certain examples, shell receiving feature 197 corresponds to block receiving feature 126. The contact block 180 is designed to have retaining features 186 that correspond with the block retaining features 128 of the shell 110. In certain examples, the contact block 180 is removably held in place when assembled with the shell 110. In certain examples, the contact block 180 is permanently fixed to the shell 110. In certain examples, the retaining feature 186 is an adhesive such as an epoxy that provide permanent fixation between the contact block 180 and the shell 110. FIG. 40, shows an example contact block 180. The contact block 180 includes a main body 188. The contact block 180 includes a plug end 182 that extends toward the opening 112 at first end 102 within the channel 113 when assembled. The plug end 182 includes a mating interface 184 that is designed to interface with the plug 240 at the mating region 120 of the shell 110. In certain examples, the contact block 180 includes at least one contact 190. The contact 190 includes a first contact end 192 at the mating interface 184. The contact includes a second contact end 194. In the example shown on FIG. 40, the contact block includes ten contacts 190 with five in an upper row and five in a lower row. In certain examples, the second contact end 194 extends out from the shell 110 and from the main body 188. The second contact end 194 may connect to the PCB 300, 600.

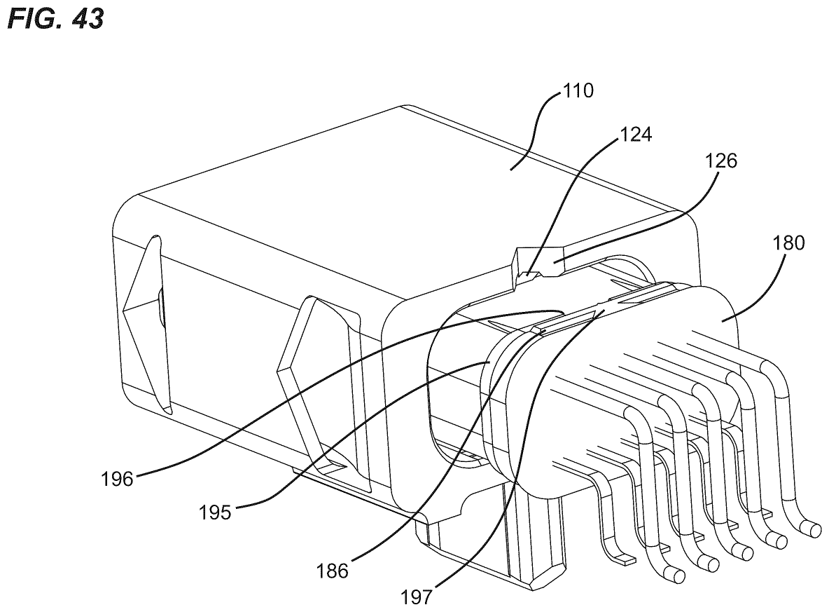

FIG. 42 shows an example plug 240. In certain examples, the plug 240 includes at least one electrical contact 244 that corresponds to the at least one electrical contact 190 of the contact block 180. In the example shown on FIG. 42, the plug 240 includes ten contacts 244 with five in an upper row and five in a lower row which correspond to the contacts 190 of the contact block 180, as shown in FIG. 40. In certain examples, the plug 240 includes retention features 242 that correspond to the retaining features 156 of the latch arms 140. In certain examples, the retention features 242 are indents, channels, or divots that engage the retaining feature 156 when the retaining feature 156 is a bump or protrusion. In certain examples, the plug 240 includes a plug cable 246 extending from a first end 248 of the plug 240. A second end 350 of the plug 240 interacts with the connector 100. In certain examples, the plug 240 includes a plug surface 252 that forms a close fit with the opening 112 such that the plug 240 must be in proper alignment about the plug axis 106 in order to insert the plug 240 into the shell 110.

FIG. 39 shows an example of connector 100 having a plug 240 inserted. During insertion of the plug 240, in a first phase, the pair of latch arms 140 first flex along a length of the latch arm 140 extending from the anchor 142 until the contact region 160 engages the contact portion 162 of the shell 110. Once the contact region 160 is touching the shell 110, in a second phase, the pair of latch arms 140 flex in a region extending toward the tip 144 and retaining feature 156 from the contact region 160. The pair of latch arms 140 are maximally flexed at an insertion position 169 while the plug 240 is being inserted and prior to reaching the engaged position 167. FIG. 38 shows an example connector 100 with the plug 240 at the engaged position 167. The plug 240 includes corresponding retention features 242 into which the retaining features 156 seat. When the latch arms 140 are in the engaged position 167, the plug 240 is electrically shielded, as it is at least partially surrounded by the shell 110, including the latch arms 140 connecting to the shell and to the PCB 300.

As previously noted, the stresses within the latch arm 140 vary during an insertion process, resulting in flexure of different portions of the latch arm 140 at different phases of such an insertion (or equivalent removal) process. FIGS. 44A-44D show the stresses within the latch arm 140 at different stages, or phases, of an example insertion process in which a plug 240 is inserted into the connector 100. FIG. 44A shows the latch arm 140 in an unstressed state just prior to contact with the plug 240. As the plug 240 makes first contact with the latch arm 140, the latch arm begins to flex, causing internal stress within the latch arm. FIG. 44B shows the latch arm 140 during a first flexing phase, just after contact with the plug 240. The latch arm 140 acts as a cantilevered beam with a fixed end. Stress is greatest where the moment is greatest, which is at the fixed end of the cantilevered beam. For the latch arm 140, the internal stress is greatest at the exterior side of the anchor 142, as seen in FIG. 44B. Internal stress also extends along the first inwardly-oriented section 149. As the latch arm 140 continues to flex in response to the insertion of the plug 240, the contact region 160 makes contact with the shell 110 at the contact portion 162. FIG. 44C shows an example of the latch arm 140 just as contact is being made between the contact region 160 and the contact portion 162, transitioning from a first phase to a second phase of flexing. Just as the contact region 160 and the contact portion 162 touch, the stress at the anchor 142 reaches a maximum. The internal stress also extends along the first inwardly-oriented section 149 and the first outwardly-oriented section 150, with the stress greatest at the exterior of the latch arm 140. The bending or flexing of the latch arm 140 becomes more complex once the contact region 160 and the contact portion 162 touch. The latch arm 140 acts as a complex cantilevered beam where the fixed end is at the anchor 142, but the cantilevered beam is also constrained at the contact portion 160 in terms of its movement outwardly (e.g., preventing movement outwardly past contact with the contact portion 162). While the contact portion 160 is able to move parallel to the plug axis 106 somewhat during the second phase, it is prevented from further outward deflection normal to the plug axis 106. The tip 144 of the latch arm 140 becomes maximally deflected once the plug surface 252 contacts the retaining feature 156 at the second inward apex 155. When the tip 144 continues toward maximal deflection, after the contact portion has been constrained, the stress reduces at the anchor 142 and increases at the interior side 148 of first inward apex 153. FIG. 44D shows an example of the latch arm 140 in maximum deflection when the plug 240 is being inserted, prior to the retaining feature 156 seating into the retention feature 242. In particular, FIG. 44D shows that the stress is more evenly distributed between the first and inwardly-oriented sections 149, 151 and between the first outwardly oriented section 150. During insertion of the plug 240, the tip 144 of the latch arm 140 remains maximally deflected until the retaining feature 156 seats into the retention feature 242, at which point stress decreases to a level more similar to that shown in FIG. 44C.

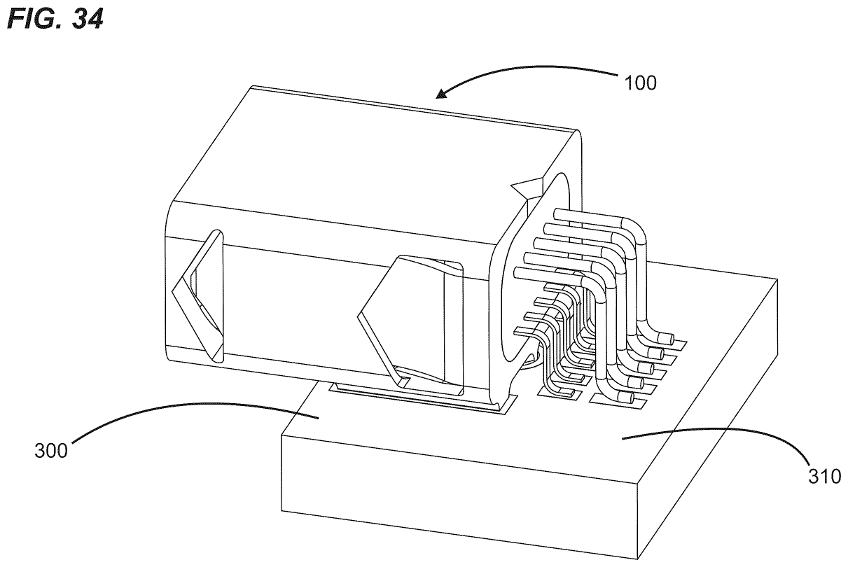

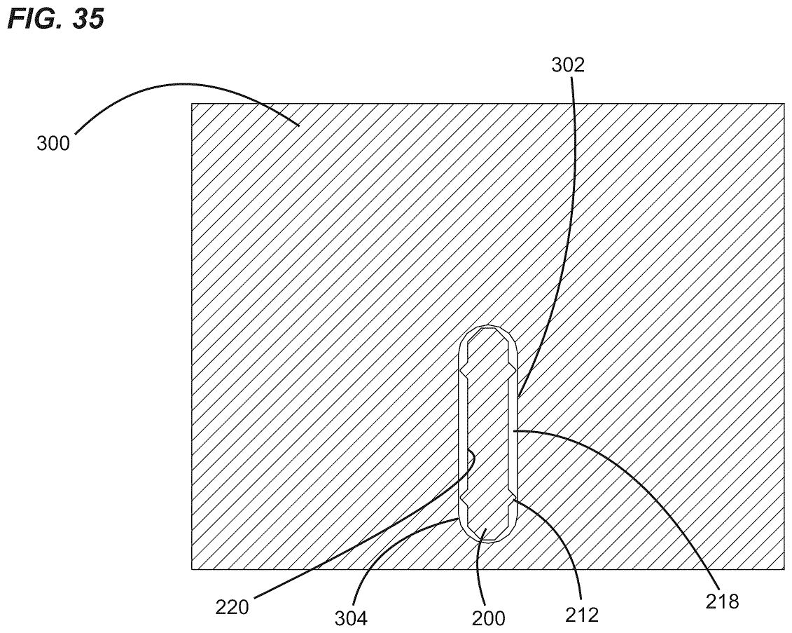

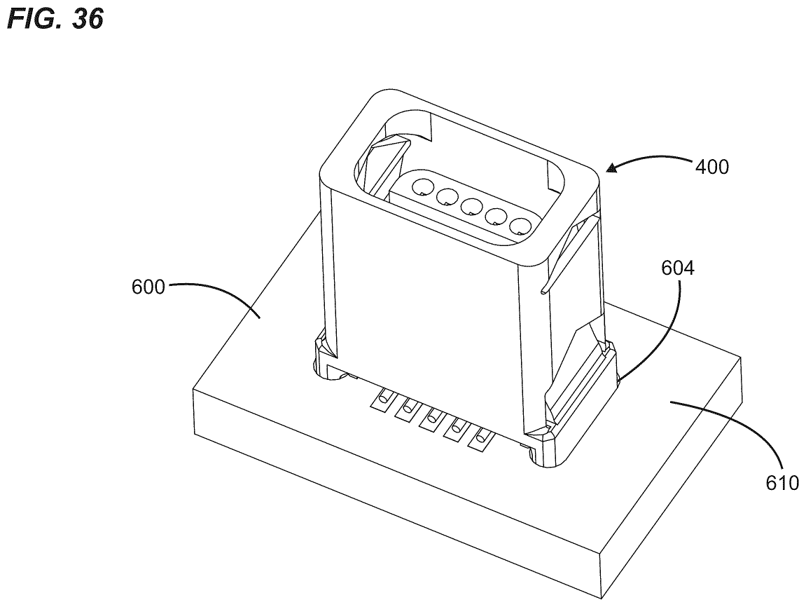

In the example shown, connector 100 may be connected to the PCB 300 such that the mounting fin 200 is first inserted into the PCB slot 304. The stabilizing pads 230 are seated onto the PCB surface 310. Then solder is used to secure the mounting fin 200 to the PCB 300. The contact 190 is also attached to the PCB. An example of the attachment between the connector 100 and the PCB 300 is shown on FIG. 34.

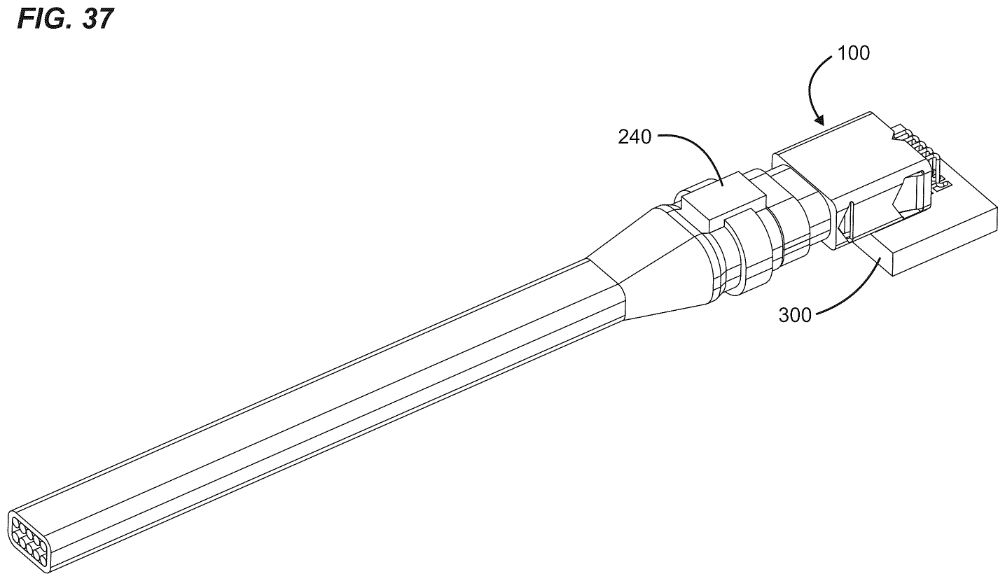

The connector 400 may be connected to the PCB 600 such that the two mounting fins 500 are first inserted into corresponding PCB slots 604. The stabilizing pads 530 are seated onto the PCB surface 610. Then solder is used to weld the mounting fins 500 to the PCB 600. An example of the attachment between the connector 400 and the PCB 600 is shown on FIG. 36.

The connector described above provides numerous advantageous design features that may be taken alone or in combination. In certain examples, the latch arms provide enhanced retention force and reduced latch stress with dual flex positions. In certain examples, the latch arms provide integral shielding through additive manufacturing processes. In certain examples, the latch arms enable a compact design by extending from the exterior to the interior of the shell. In certain examples, the mounting fin provides both tight fit with the PCB and clearance for solder through the use of ridges. Other inventive aspects are apparent from the disclosure above. While limited embodiments are illustrated, these inventive aspects apply equally to other types of connectors.

Although aspects of the present disclosure are described in a context primarily relating to electrical connectors for transmission of power and/or data signals, the structures and methods described herein may be utilized in other types of connectors, such as telecommunications connectors generally, including optical fiber connectors or various other types of telecommunications connectors. It is noted, however, that the features of the present application have particular advantages in applications requiring some or all of the advantages of compactness and electrical shielding as may be provided in accordance with the embodiments described previously.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the claimed subject matter.

What is claimed is:

1. An electrical connector comprising:
a shell including a channel extending from an opening at a first end and continuing toward a second end, the shell including:
a latch arm extending from an anchor and continuing toward the first end to a tip, the latch arm having a contact region at an intermediate position between the anchor and the tip, the latch arm being flexible in a first phase and a second phase, the first phase corresponding to flexing initiating proximate the anchor, and second phase corresponding to flexing concentrating proximate to the contact region in response to the contact region engaging a contact portion of the shell;
a contact block positioned at least partially within the channel, the contact block including a mating interface; and
at least one electrical contact connected to the contact block with a first contact end at the mating interface.

2. The electrical connector of claim 1, wherein the latch arm is integrally connected to the shell at the anchor.

3. The electrical connector of claim 1, wherein the latch arm includes a first outward apex formed by a curve at the contact region, wherein the contact portion is a portion of a sidewall of the shell, wherein when the contact region engages the contact portion of the shell, the first outward apex contacts the sidewall such that other portions of the latch arm do not contact the sidewall.

4. The electrical connector of claim 1, wherein the latch arm forms an alternating curve having a first inward apex and a second inward apex with a first outward apex between them.

5. The electrical connector of claim 4, wherein the second inward apex includes a retaining feature.

6. The electrical connector of claim 1, wherein the shell includes a first side opening positioned about a tip region of the shell such that the tip has clearance to flex to an insertion position.

7. The electrical connector of claim 1, wherein the latch arm extends from an exterior of the shell at an exterior side of the latch arm at the anchor to an interior of the shell at the tip of the latch arm.

8. The electrical connector of claim 7, wherein the shell includes a second side opening where the exterior side of the latch arm transitions from the exterior to the interior of the shell.

9. The electrical connector of claim 1, wherein the latch arm includes an interior side and an exterior side, wherein the interior and exterior sides are curved flat surfaces, wherein the interior and exterior sides are parallel with each other about a majority of a length of the latch arm.

10. The electrical connector of claim 1, wherein the shell further includes a mounting fin with a plurality of ridges, wherein neighboring ridges of the plurality of ridges form solder channels between them.

11. The electrical connector of claim 1, wherein the shell has a length of less than 0.30 inches between the first end and the second end, wherein the latch arm is shorter than the shell length.

12. The electrical connector of claim 1, wherein the shell is made using an additive manufacturing process.

13. A connector comprising:
a shell including:
a main body;
an opening at a first end of the main body;
a channel extending into the main body from the opening;
a mounting fin extending from an exterior surface of the shell in a first direction, the mounting fin having a first side and a second side, each of the first and second sides including a plurality of ridges extending in the first direction along at least a portion of the mounting fin, neighboring ridges of the plurality of ridges forming solder channels between them;
a contact block positioned at least partially within the channel, the contact block including a mating interface; and
at least one electrical contact connected to the contact block with a first contact end at the mating interface.

14. The connector of claim 13, wherein the mounting fin is integrally formed with the shell.

15. The connector of claim 13, wherein the plurality of ridges extend along a majority of a length of the mounting fin in the first direction.

16. The connector of claim 13, wherein the plurality of ridges have a height between 0.002 and 0.006 inches.

17. The connector of claim 13, wherein the shell further includes a pair of latch arms that are flexible in accordance with a first phase and a second phase, wherein the first phase corresponding to flexing initiating proximate an anchor and the second phase corresponding to flexing initiating proximate a contact region of the pair of latch arms in response to the contact region engaging a contact portion of the shell.

18. The connector of claim 13, wherein the mounting fin extends a length along the exterior surface of the shell that is between 25% and 75% a length of the shell between the first and second ends.

19. A shell for an electrical connector comprising:
a main body having an opening at a first end and forming a channel that extends from the opening and toward a second end within the main body;
a pair of latch arms integrally formed with the main body and positioned at least partially within the opening, the pair of latch arms being flexible in first and second phases, the first phase corresponding to flexing initiating proximate an anchor and the second phase corresponding to flexing initiating proximate a contact region of the pair of latch arms in response to the contact region engaging a contact portion on an interior surface of the main body.

20. The shell of claim 19, wherein the pair of latch arms each includes a first outward apex formed by a curve at the contact region, wherein when the contact region engages the contact portion of the shell, the first outward apex contacts a sidewall of the shell such that other portions of the pair latch arms do not contact the sidewall.
